(19) United States
(12) Patent Application Publication
(10) Pub. No.: US 2025/0393014 A1
(43) Pub. Date: Dec. 25, 2025

(54) TECHNIQUES FOR PRIORITIZING SIDELINK POSITIONING INFORMATION

(71) Applicant: Intel Corporation, Santa Clara, CA (US)

(72) Inventors: GANG XIONG, Portland, OR (US); DEBDEEP CHATTERJEE, San Jose, CA (US); KILIAN ROTH, Munich (DE); TOUFIQUL ISLAM, Milpitas, CA (US); JIHYUN LEE, Santa Clara, CA (US)

(73) Assignee: Intel Corporation, Santa Clara, CA (US)

(21) Appl. No.: 18/880,675

(22) PCT Filed: Aug. 2, 2023
(86) PCT No.: PCT/US23/29315

§ 371 Date: Jan. 2, 2025

Related U.S. Application Data
(60) Provisional application No. 63/394,482, filed on Aug. 2, 2022.
(60) Provisional application No. 63/494,646, filed on Apr. 6, 2023.

(51) Int. Cl. H04W 64/00; H04W 72/25

(52) U.S. Cl. CPC H04W 64/00; H04W 72/25

(57) ABSTRACT

Techniques relating to prioritization of sidelink positioning reference signals (SL PRS) for sidelink positioning in a new radio (NR) system are described. In one embodiment. a method to manage communications for a user equipment (UE) includes detecting a set of overlapping symbols between a SL PRS and a message in a slot for a frame in a time domain of a NR system, retrieving priority information for the SL PRS from a data storage device, and determining a schedule for transmission or reception of the SL PRS and the message based on the priority information. Other embodiments are described and claimed.

This application claims the benefit of and priority to previously filed U.S. Provisional Patent Application Ser. No. 63/494,646, filed Apr. 6, 2023, entitled “MECHANISMS ON PRIORITIZATION OF SL-PRS TRANSMISSION OR RECEPTION FOR SIDELINK POSITIONING”, and previously filed U.S. Provisional Patent Application Ser. No. 63/394,482, filed Aug. 2, 2022, entitled “MECHANISMS ON PRIORITIZATION OF SL-PRS TRANSMISSION OR RECEPTION FOR SIDELINK POSITIONING”, which are both hereby incorporated by reference in their entireties.

### BACKGROUND

New radio (NR) Vehicle-to-Vehicle (V2V) or Vehicle-to-Anything (V2X) sidelink communication is a synchronous communication system with distributed resource allocation. User equipments (UEs) autonomously select resources for sidelink communications, including transmission and/or reception, based on predefined sensing and resource selection procedures. The sensing and resource selection procedures are designed to reduce potential conflicts in sidelink communications or resource reservations (e.g., collisions or half-duplex conflicts). When there is a conflict between sidelink communications or other signals, however, the UEs need improved techniques to resolve the conflict to avoid or reduce collisions. As such, there is a need to resolve conflict decisions by UEs and thereby improve overall reliability of NR V2V or V2X sidelink communications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless communication system in accordance with one embodiment.

FIG. 2 illustrates second wireless communications system in accordance with one embodiment.

FIG. 3 illustrates an operating environment in accordance with one embodiment.

FIG. 4 illustrates an operating environment in accordance with one embodiment.

FIG. 5 illustrates an operating environment in accordance with one embodiment.

FIG. 6 illustrates an operating environment in accordance with one embodiment.

FIG. 7 illustrates operating environment in accordance with one embodiment.

FIG. 8 illustrates an apparatus in accordance with one embodiment.

FIG. 9 illustrates a logic flow in accordance with one embodiment.

FIG. 10 illustrates a logic flow in accordance with one embodiment.

FIG. 11 illustrates a logic flow in accordance with one embodiment.

FIG. 12 illustrates a logic flow in accordance with one embodiment.

FIG. 13 illustrates a message flow in accordance with one embodiment.

FIG. 14 illustrates a first network in accordance with one embodiment.

FIG. 15 illustrates a second network in accordance with one embodiment.

FIG. 16 illustrates a third network in accordance with one embodiment.

FIG. 17 illustrates a computer readable storage medium in accordance with one embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Embodiments may generally relate to the field of wireless communications systems. Some embodiments are particularly directed to techniques for prioritization of sidelink position reference signal (SL PRS) transmission or reception for sidelink positioning in a fifth generation (5G) or sixth generation (6G) new radio (NR) wireless system. In one embodiment, for example, a UE configures a priority value for a SL PRS transmission or reception. The UE determines whether SL PRS communications have a higher priority than other types of communications in accordance with priority information, such as a configured priority value for the UE or the other types of communications. The UE then generates a schedule to communicate some or all of the SL PRS or other types of communication based on the priority information.

Mobile communication has evolved significantly from early voice systems to today's highly sophisticated integrated communication platform. The next generation wireless communication system, such as 5G or 6G new radio (NR), will provide access to information and sharing of data anywhere, anytime by various users and applications. NR is expected to be a unified network/system that target to meet vastly different and sometime conflicting performance dimensions and services. Such diverse multi-dimensional specifications are driven by different services and applications. In general, NR will evolve based on Third Generation Partnership Project (3GPP) long-term evolution (LTE) and LTE-Advanced with additional potential new Radio Access Technologies (RATs) to enrich people lives with better, simple, and seamless wireless connectivity solutions. NR will enable everything connected by wireless and deliver fast, rich contents and services.

NR supports highly precise positioning in the vertical and horizontal dimensions, which relies on timing-based, angle-based, power-based or hybrid techniques to estimate the user location in the network. With wide bandwidth for positioning signal and beamforming capability in a millimeter wave (mmWave) frequency band, higher positioning accuracy can be achieved by RAT dependent positioning techniques. Note that in 3GPP Release 16 (Rel-16), downlink positioning reference signal (DL-PRS) and uplink sounding reference signal (UL-SRS) for positioning were introduced as an enabler to achieve target performance characteristics.

3GPP Release 18 (Rel-18) addresses use cases such as autonomous driving, sidelink or vehicle-to-everything (V2X) based positioning. More specifically, various scenarios including in-coverage, partial coverage, out of network coverage need to be considered for sidelink positioning. To meet the positioning accuracy specification, it is envisioned that a new sidelink reference signal, e.g., sidelink position reference signal (SL PRS), will be introduced.

A SL PRS is a specific type of reference signal used in cellular communication systems for positioning purposes in sidelink (SL) transmissions. It is introduced as a part of the 5G NR standard, designed to enable accurate and reliable positioning information for devices within the same network. In 5G NR, sidelink refers to direct communication between user equipment (UE) devices without the need to go through a central base station. This direct device-to-device (D2D) communication allows for low-latency and efficient data exchange, which is especially beneficial in scenarios like vehicular communication, public safety, and Internet of Things (IoT) applications. The SL PRS is used to assist in determining the location of a device, which is essential for various positioning-based services and applications. It helps in calculating the distance between the devices and enables time and frequency synchronization, making it possible to triangulate the position accurately. The SL PRS is transmitted by devices periodically, and other devices within the proximity can use the received signal to estimate their relative positions. This allows devices to perform cooperative positioning, where each device assists others in determining their positions. By leveraging the SL PRS and other positioning-related information, 5G NR enables precise and robust positioning capabilities, facilitating the implementation of location-based services and applications that require accurate device location information.

In NR sidelink, 3GPP defines a prioritization rule between SL communications, both transmission and reception, and other types of communications, such as uplink (UL) transmission. In general, the random access (RA) procedure on the physical random access channel (PRACH) is assigned a higher priority relative to SL transmission or reception. In one case, this includes certain types of messages, such as PRACH data such as Message 3 (Msg3) of the 4-step RACH (4SR) physical uplink shared channel (PUSCH) initial transmission and retransmission, the 2-step RACH (2SR) enhancement of Message A (MsgA) PUSCH, physical uplink control channel (PUCCH) carrying hybrid automatic repeat request (HARQ) acknowledgements (HARQ-ACK) information of corresponding Message B (MsgB) PDSCH transmission, Message 4 (Msg4) of 4SR, and others. Some or all of these message types may have a higher priority than SL communications. In cases where a UE is not capable of simultaneously transmission on the UL and transmission/reception on the SL in a carrier or in two respective carriers, the UE transmits only the uplink channels and drops the sidelink communications (e.g., transmission and/or reception).

For sidelink positioning operations, the SL PRS may overlap with other sidelink communications or uplink transmissions in a time domain. When a UE does not support simultaneous transmission or reception of sidelink and/or uplink transmissions, some or all of the symbols for the SL PRS and the other sidelink communications or the uplink transmission may need to be dropped or cancelled. As a result, certain mechanisms may need to be defined on how to prioritize the SL PRS and other sidelink transmission/reception or uplink transmission.

Techniques relating to prioritization of SL PRS for sidelink positioning in a NR system are described. In one embodiment, for example, a method to manage communications for a user equipment (UE) includes detecting a set of overlapping symbols between a SL PRS and a message in a slot for a frame in a time domain of a NR system, retrieving priority information for the SL PRS from a data storage device, and determining a schedule for transmission or reception of the SL PRS and the message based on the priority information. Some or all of the symbols for the SL PRS and/or the message are communicated based on the schedule. In this way, the UE reduces potential collisions while maintaining throughput for higher priority communications within the NR system. As a result, a UE or other devices within a NR system improve sidelink positioning in a device or NR system while require less compute resources, memory resources, bandwidth resources, and other scarce and valuable resources in the device or the NR system. Other embodiments are described and claimed.

In one embodiment, the term “SL communications” may refer to communicating symbols for the SL communications between a first UE and a second UE, such as a transmission of symbols for the SL communications from a first UE to a second UE or reception of symbols for the SL communications from the second UE by the first UE, or vice-versa. In one embodiment, the term “UL communications” may refer to transmission of symbols for the UL communications from a UE to one or more network entities in the NR system, such as a radio access network (RAN). In one embodiment, the term “DL communications” may refer to reception of symbols for DL communications from a network entity such as a RAN by a UE.

In an embodiment, for example, “symbols for SL PRS transmission” or “SL PRS transmission” may refer to the symbols corresponding to a SL PRS resource. Alternatively, “symbols for SL PRS transmission” or “SL PRS transmission” may refer to the symbols corresponding to a SL PRS resource set that may be mapped to one or more occasions of a SL PRS resource pool. As yet another alternative, “symbols for SL PRS transmission” or “SL PRS transmission” may refer to the symbols corresponding to an occasion of SL PRS resource pool. In a further example, “symbols for SL PRS transmission” or “SL PRS transmission” may refer to the symbols corresponding to an occasion of SL PRS resource pool when the SL PRS resource pool is configured for UE-autonomous resource selection.

In one embodiment, for example, “symbols for SL PRS reception” or “SL PRS reception” may refer to the symbols corresponding to a SL PRS resource. Alternatively, “symbols for SL PRS reception” or “SL PRS reception” may refer to the symbols corresponding to a SL PRS resource set that may be mapped to one or more occasions of a SL PRS resource pool. As yet another alternative, “symbols for SL PRS reception” or “SL PRS reception” may refer to the symbols corresponding to an occasion of SL PRS resource pool. In a further example, “symbols for SL PRS reception” or “SL PRS reception” may refer to the symbols corresponding to an occasion of SL PRS resource pool when the SL PRS resource pool is configured for UE-autonomous resource selection.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

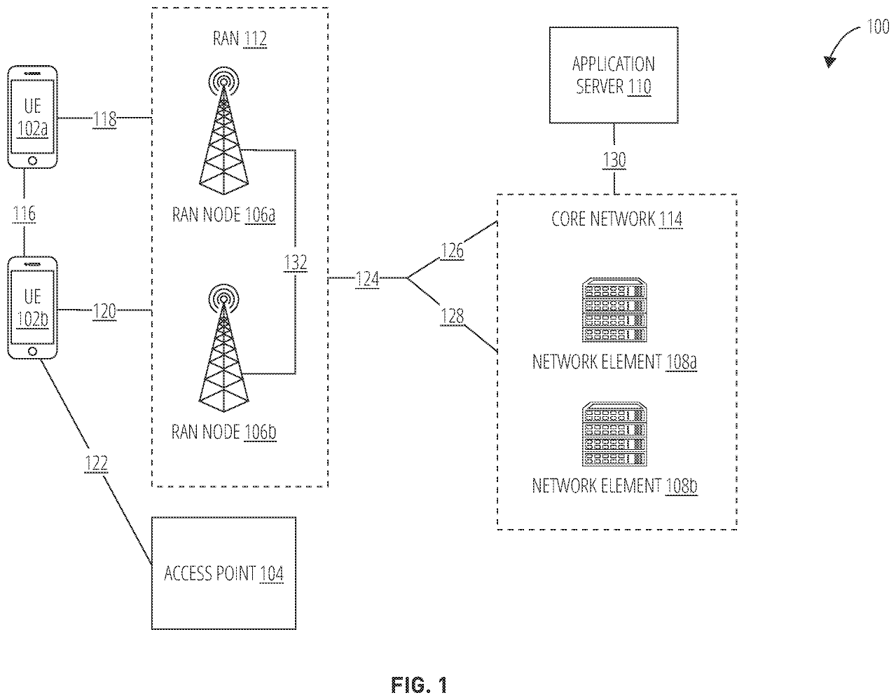

FIG. 1 illustrates an example of a wireless communication wireless communications system 100. For purposes of convenience and without limitation, the example wireless communications system 100 is described in the context of the long-term evolution (LTE) and fifth generation (5G) new radio (NR) (5G NR) or 6G NR cellular networks communication standards. The 5G NR or 6G NR system may be defined, at least in part, by various Third Generation Partnership Project (3GPP) Technical Standards (TS), Technical Reports (TR) and/or Work Items (WI).

Various embodiments discussed herein may be implemented in a wireless communications system 100 as defined by the 3GPP TS 38.212 titled “Technical Specification Group Radio Access Network; NR; Multiplexing and channel coding,” Release 17.5.0, March 2023 (“3GPP TS 38.212”); and 3GPP TS 38.213 titled “Technical Specification Group Radio Access Network; NR; Physical layer procedures for control,” Release 17.6.0, June 2023 (“3GPP TS 28.213); both including any progeny, revisions or variants. It may be appreciated that the embodiments may be implemented in accordance with other 3GPP TS, TR and WI, as well as other wireless standards released by other standards entities. Embodiments are not limited in this context.

The wireless communications system 100 includes UE 102a and UE 102b (collectively referred to as the “UEs 102”). In this example, the UEs 102 are illustrated as smartphones (e.g., handheld touchscreen mobile computing devices connectable to one or more cellular networks). In other examples, any of the UEs 102 can include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IoT) devices, or combinations of them, among others.

In some implementations, any of the UEs 102 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which can include uniquely identifiable embedded computing devices (within the Internet infrastructure), with short-lived connections. The IoT UEs may execute background applications (e.g., keep-alive messages or status updates) to facilitate the connections of the IoT network.

The UEs 102 are configured to connect (e.g., communicatively couple) with a radio access network (RAN) 112. In some implementations, the RAN 112 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 112 that operates in a 5G NR wireless communications system 100, and the term “E-UTRAN” may refer to a RAN 112 that operates in an LTE or 4G wireless communications system 100.

To connect to the RAN 112, the UEs 102 utilize connections (or channels) 118 and 120, respectively, each of which can include a physical communications interface or layer, as described below. In this example, the connections 118 and 120 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The UE 102b is shown to be configured to access an access point (AP) 104 (also referred to as “WLAN node 104,” “WLAN 104,” “WLAN Termination 104,” “WT 104” or the like) using a connection 122. The connection 122 can include a local wireless connection, such as a connection consistent with any IEEE 802.11 protocol, in which the AP 104 would include a wireless fidelity (Wi-Fi) router. In this example, the AP 104 is shown to be connected to the Internet without connecting to the core network of the wireless system, as described in further detail below.

The RAN 112 can include one or more nodes such as RAN nodes 106a and 106b (collectively referred to as “RAN nodes 106” or “RAN node 106”) that enable the connections 118 and 120. As used herein, the terms “access node,” “access point,” or the like may describe equipment that provides the radio baseband functions for data or voice connectivity, or both, between a network and one or more users. These access nodes can be referred to as base stations (BS), gNodeBs, gNBs, eNodeBs, eNBs, NodeBs, RAN nodes, rode side units (RSUs), transmission reception points (TRxPs or TRPs), and the link, and can include ground stations (e.g., terrestrial access points) or satellite stations providing coverage within a geographic area (e.g., a cell), among others. As used herein, the term “NG RAN node” may refer to a RAN node 106 that operates in an 5G NR wireless communications system 100 (for example, a gNB), and the term “E-UTRAN node” may refer to a RAN node 106 that operates in an LTE or 4G wireless communications system 100 (e.g., an eNB). In some implementations, the RAN nodes 106 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

In some implementations, some or all of the RAN nodes 106 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 106; a medium access control (MAC)/physical layer (PHY) split in which RRC, PDCP, MAC, and radio link control (RLC) layers are operated by the CRAN/vBBUP and the PHY layer is operated by individual RAN nodes 106; or a “lower PHY” split in which RRC, PDCP, RLC, and MAC layers and upper portions of the PHY layer are operated by the CRAN/vBBUP and lower portions of the PHY layer are operated by individual RAN nodes 106. This virtualized framework allows the freed-up processor cores of the RAN nodes 106 to perform, for example, other virtualized applications. In some implementations, an individual RAN node 106 may represent individual gNB distributed units (DUs) that are connected to a gNB central unit (CU) using individual F1 interfaces (not shown in FIG. 1). In some implementations, the gNB-DUs can include one or more remote radio heads or RFEMs, and the gNB-CU may be operated by a server that is located in the RAN 112 (not shown) or by a server pool in a similar manner as the CRAN/vBBUP. Additionally, or alternatively, one or more of the RAN nodes 106 may be next generation eNBs (ng-eNBs), including RAN nodes that provide E-UTRA user plane and control plane protocol terminations toward the UEs 102, and are connected to a 5G core network (e.g., core network 114) using a next generation interface.

In vehicle-to-everything (V2X) scenarios, one or more of the RAN nodes 106 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 102 (vUEs 102). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and can include a network interface controller to provide a wired connection (e.g., Ethernet) to a traffic signal controller or a backhaul network, or both.

Any of the RAN nodes 106 can terminate the air interface protocol and can be the first point of contact for the UEs 102. In some implementations, any of the RAN nodes 106 can fulfill various logical functions for the RAN 112 including, but not limited to, radio network controller (RNC) functions such as radio bearer management, uplink and downlink dynamic radio resource management and data packet scheduling, and mobility management.

In some implementations, the UEs 102 can be configured to communicate using orthogonal frequency division multiplexing (OFDM) communication signals with each other or with any of the RAN nodes 106 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

The RAN nodes 106 can transmit to the UEs 102 over various channels. Various examples of downlink communication channels include Physical Broadcast Channel (PBCH), Physical Downlink Control Channel (PDCCH), and Physical Downlink Shared Channel (PDSCH). Other types of downlink channels are possible. The UEs 102 can transmit to the RAN nodes 106 over various channels. Various examples of uplink communication channels include Physical Uplink Shared Channel (PUSCH), Physical Uplink Control Channel (PUCCH), and Physical Random Access Channel (PRACH). Other types of uplink channels are possible.

In some implementations, a downlink resource grid can be used for downlink transmissions from any of the RAN nodes 106 to the UEs 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The PDSCH carries user data and higher-layer signaling to the UEs 102. The PDCCH carries information about the transport format and resource allocations related to the PDSCH channel, among other things. It may also inform the UEs 102 about the transport format, resource allocation, and hybrid automatic repeat request (HARQ) information related to the uplink shared channel. Downlink scheduling (e.g., assigning control and shared channel resource blocks to the UE 102b within a cell) may be performed at any of the RAN nodes 106 based on channel quality information fed back from any of the UEs 102. The downlink resource assignment information may be sent on the PDCCH used for (e.g., assigned to) each of the UEs 102.

The PDCCH uses control channel elements (CCEs) to convey the control information. Before being mapped to resource elements, the PDCCH complex-valued symbols may first be organized into quadruplets, which may then be permuted using a sub-block interleaver for rate matching. In some implementations, each PDCCH may be transmitted using one or more of these CCEs, in which each CCE may correspond to nine sets of four physical resource elements collectively referred to as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. In LTE, there can be four or more different PDCCH formats defined with different numbers of CCEs (e.g., aggregation level, L=1, 2, 4, or 8).

Some implementations may use concepts for resource allocation for control channel information that are an extension of the above-described concepts. For example, some implementations may utilize an enhanced PDCCH (EPDCCH) that uses PDSCH resources for control information transmission. The EPDCCH may be transmitted using one or more enhanced CCEs (ECCEs). Similar to above, each ECCE may correspond to nine sets of four physical resource elements collectively referred to as an enhanced REG (EREG). An ECCE may have other numbers of EREGs.

The RAN nodes 106 are configured to communicate with one another using an interface 132. In examples, such as where the wireless communications system 100 is an LTE system (e.g., when the core network 114 is an evolved packet core (EPC) network), the interface 132 may be an X2 interface 132. The X2 interface may be defined between two or more RAN nodes 106 (e.g., two or more eNBs and the like) that connect to the EPC 114, or between two eNBs connecting to EPC 114, or both. In some implementations, the X2 interface can include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 102 from a secondary eNB for user data; information of PDCP PDUs that were not delivered to a UE 102; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionalities.

In some implementations, such as where the wireless communications system 100 is a 5G NR system (e.g., when the core network 114 is a 5G core network), the interface 132 may be an Xn interface 132. The Xn interface may be defined between two or more RAN nodes 106 (e.g., two or more gNBs and the like) that connect to the 5G core network 114, between a RAN node 106 (e.g., a gNB) connecting to the 5G core network 114 and an eNB, or between two eNBs connecting to the 5G core network 114, or combinations of them. In some implementations, the Xn interface can include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN nodes 106, among other functionalities. The mobility support can include context transfer from an old (source) serving RAN node 106 to new (target) serving RAN node 106, and control of user plane tunnels between old (source) serving RAN node 106 to new (target) serving RAN node 106. A protocol stack of the Xn-U can include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack can include an application layer signaling protocol (referred to as Xn Application Protocol (Xn-AP or XnAP)) and a transport network layer (TNL) that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 112 is shown to be communicatively coupled to a core network 114 (referred to as a “CN 114”). The CN 114 includes multiple network elements, such as network element 108a and network element 108b (collectively referred to as the “network elements 108”), which are configured to offer various data and telecommunications services to customers/subscribers (e.g., users of UEs 102) who are connected to the CN 114 using the RAN 112. The components of the CN 114 may be implemented in one physical node or separate physical nodes and can include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 114 may be referred to as a network slice, and a logical instantiation of a portion of the CN 114 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 110 may be an element offering applications that use IP bearer resources with the core network (e.g., UMTS packet services (PS) domain, LTE PS data services, among others). The application server 110 can also be configured to support one or more communication services (e.g., VoIP sessions, PTT sessions, group communication sessions, social networking services, among others) for the UEs 102 using the CN 114. The application server 110 can use an IP communications interface 130 to communicate with one or more network elements 108a.

In some implementations, the CN 114 may be a 5G core network (referred to as “5GC 114” or “5G core network 114”), and the RAN 112 may be connected with the CN 114 using a next generation interface 124. In some implementations, the next generation interface 124 may be split into two parts, a next generation user plane (NG-U) interface 114, which carries traffic data between the RAN nodes 106 and a user plane function (UPF), and the S1 control plane (NG-C) interface 126, which is a signaling interface between the RAN nodes 106 and access and mobility management functions (AMFs). Examples where the CN 114 is a 5G core network are discussed in more detail with regard to later figures.

In some implementations, the CN 114 may be an EPC (referred to as “EPC 114” or the like), and the RAN 112 may be connected with the CN 114 using an S1 interface 124. In some implementations, the S1 interface 124 may be split into two parts, an S1 user plane (S1-U) interface 128, which carries traffic data between the RAN nodes 106 and the serving gateway (S-GW), and the S1-MME interface 126, which is a signaling interface between the RAN nodes 106 and mobility management entities (MMEs).

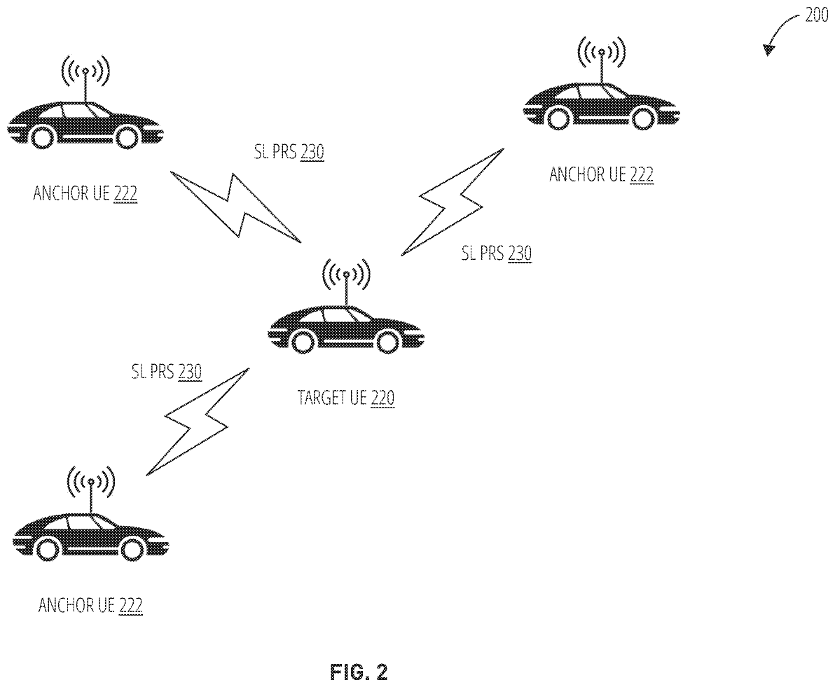

FIG. 2 illustrates a wireless communications system 200. The wireless communications system 200 is an example implementation for a portion of the wireless communications system 100 illustrated in FIG. 1. The wireless communications system 200 depicts one example of sidelink positioning operations and signals with a set of anchor UEs 222 and a target UE 220. In the example, the target UE 220 represents the UE to be positioned while the anchor UEs 222 represent the UEs supporting positioning of the target UE 220, e.g., by transmitting and/or receiving SL PRS 230 and providing positioning-related information. Note that SL PRS 230 can be transmitted between the anchor UEs 222 and the target UE 220, and between the target UE 220 and the anchor UEs 222, for sidelink positioning operations.

In 5G NR, sidelink communication refers to direct communication between UE, such as smartphones or IoT devices, without the need for a traditional centralized base station such as a gNodeB. This form of communication can be used for various applications, such as vehicular communication, public safety, and peer-to-peer sharing. In general, the target UE 220 and the anchor UEs 222 establish sidelink communications through sidelink procedures that include sidelink capability discovery, resource allocation, and resource selection (e.g., time, frequency, and spatial resources). Once an anchor UE 222 selects a resource, the anchor UE 222 performs data transmission, and the target UE 220 receives the data transmitted by the anchor UE 222. After decoding the data received from the anchor UE 222, the target UE 220 sends an acknowledgement (ACK) if the data is successfully received or a negative acknowledgment (NACK) if the data is not successfully received. Once sidelink communications are complete, the anchor UE 222 releases the resources used for sidelink transmissions.

SL PRS 230 are used in the sidelink communication between an anchor UE 222 and a target UE 220 to provide accurate positioning information. This is particularly essential in V2V or V2X communication in autonomous driving or safety-critical scenarios, where precise location information is required. The anchor UE 222 transmits the SL PRS 230 in the allocated sidelink resources. This signal contains specific patterns or codes that allow it to be distinguished from other types of signals. The SL PRS 230 is used for both communication and for the positioning of UEs as well.

The target UE 220 receives the SL PRS 230 from the anchor UE 222. Given that the SL PRS 230 has known properties, the target UE 220 can analyze the received signal and compare it to the expected signal. The target UE 220 calculates a time difference between when the anchor UE 222 transmits the SL PRS 230 and when the target UE 220 receives the SL PRS 230. The target UE 220 then calculates the distance between the anchor UE 222 and the target UE 220 based on the time difference. This calculation typically involves determining the Time of Arrival (ToA) or Time Difference of Arrival (TDoA) of the signals. Based on the calculated distance and known transmission direction (if available), the target UE 220 can estimate the position of the anchor UE 222.

If the target UE 220 receives SL PRS 230 from multiple anchor UEs 222, the target UE 220 can use multilateration techniques to calculate more accurate position information. Multilateration is a navigation and surveillance technique used to determine the location of an object by measuring the TDoA of a signal from the object to multiple known locations, and it is commonly used in navigation systems such as GPS and cellular networks for positioning.

The target UE 220 can then use this positioning information for various applications, such as autonomous driving, traffic management, emergency services, etc., which rely on the precise location of the UEs.

In addition to SL PRS 230, sidelink communication may also involve other types of reference signals like Sidelink Synchronization Signals (SLSS) for synchronization purposes or Demodulation Reference Signals (DMRS) for data demodulation.

In NR sidelink, 3GPP defines a prioritization rule between sidelink communications (e.g., transmission and/or reception) and uplink transmissions. As previously discussed, PRACH communications have a higher priority relative to SL communications. For example, Msg3 of the 4SR PUSCH initial transmission and retransmission, 2SR MsgA PUSCH, PUCCH carrying HARQ-ACK information of corresponding MsgB PDSCH transmission, and Msg4 of 4SR all have a higher priority level than SL transmission or reception. When a UE is not capable of simultaneously transmission on the UL and transmission/reception on the SL in a carrier or in two respective carriers, the UE transmits only the uplink channels and drops the sidelink transmission/reception.

For sidelink positioning, the SL PRS 230 may overlap with other sidelink transmission/reception and uplink transmission in a time domain. If the UE does not support simultaneous transmission or reception of sidelink and/or uplink transmission, one of the SL PRS 230 and other sidelink transmission/reception or uplink transmission may need to be dropped or cancelled. In this case, certain mechanisms may need to be defined on how to prioritize the SL PRS 230 and other sidelink transmission/reception or uplink transmission.

To solve these and other challenges, various embodiments described herein provide mechanisms for prioritization of SL PRS 230 transmission or reception for sidelink positioning. In one embodiment, for example, assume one or more symbols for SL PRS 230 transmission or reception overlaps with another sidelink transmission or reception or an uplink transmission with a higher priority in the time domain. If the UE is not capable of simultaneous transmission/reception of SL PRS 230 and the other sidelink transmission/reception or the uplink transmission in a carrier or two carriers, the UE may cancel or drop the one or more symbols for SL PRS 230 transmission or reception, respectively. Note that the one or more symbols may include the automatic gain control (AGC) symbol which is located prior to the SL PRS 230 transmission/reception and/or guard symbol which is located after the SL PRS 230 transmission/reception. Examples for the sidelink transmission or reception may include one or more following channels/signals: PSCCH/PSSCH, PSFCH, S-SS/PSBCH and/or SL PRS 230.

Despite dropping one more overlapping symbols, the UE may nonetheless transmit or receive the SL PRS 230 in the non-overlapping symbols. This preserves some of the information for SL PRS 230.

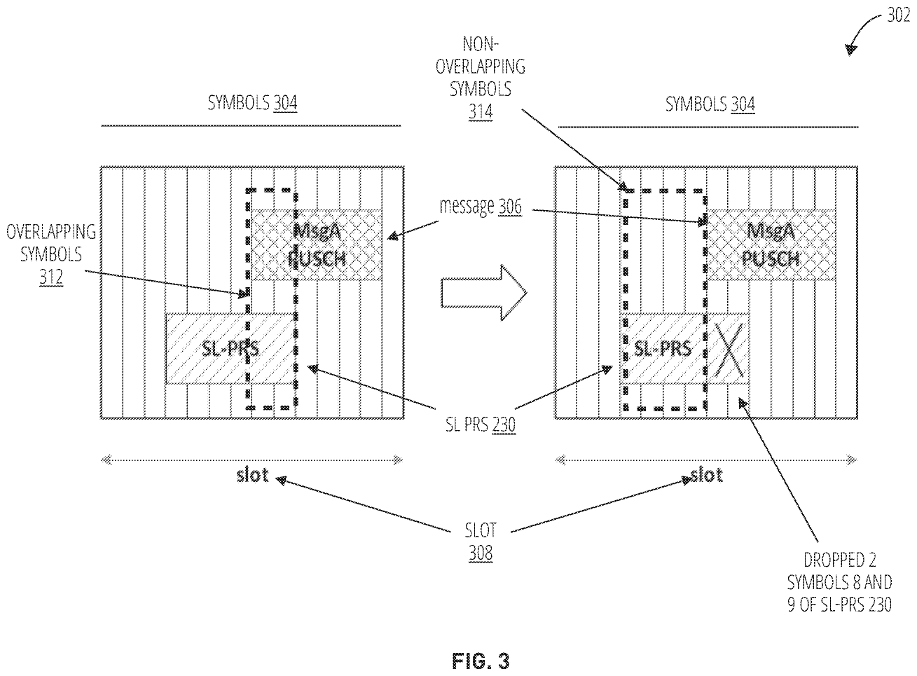

FIG. 3 through FIG. 7 illustrates various use cases and examples of a UE transmitting the SL PRS 230 or receiving the SL PRS 230. It may be appreciated that those examples that refer to a UE transmitting the SL PRS 230 are also applicable to the UE receiving the SL PRS 230, and vice-versa. Embodiments are not limited in this context.

FIG. 3 illustrates an operating environment 302. The operating environment 302 illustrates one example of a partial cancellation of SL PRS 230 in overlapping symbols.

The operating environment 302 illustrates a slot 308 from a frame of a 5G NR interface before and after cancellation of overlapping symbols. The slot 308 represents a specific unit of time on the 5G NR interface. In a wireless communications system, the frame structure defines the way information (e.g., data and control information) is organized for transmission over the radio-frequency (RF) spectrum. A frame in 5G NR is typically 10 milliseconds (ms) long and comprises subframes and slots. The number of slots in a frame or a subframe depends on the numerology (e.g., subcarrier spacing) used. With 15 kilohertz (kHz) subcarrier spacing (known as numerology 0), there are 10 subframes per frame, and each subframe comprises 2 slots. With larger subcarrier spacing, there can be more slots in a frame. For example, with a subcarrier spacing of 30 kHz (numerology 1), there would be 20 slots in a frame. In the example shown in the operating environment 302, the subcarrier spacing is 15 kHz (numerology 0). As such, the slot 308 comprises 14 symbols 304 and it lasts for 1 ms.

In the operating environment 302, a UE transmits the SL PRS 230 and a message 306 in the slot 308. In this example, the message 306 is a MsgA PUSCH. The SL PRS 230 comprises 7 symbols 304 and the message 306 comprises 6 symbols 304. As depicted in the slot 308, the SL PRS 230 and the message 306 have a set of overlapping symbols 312 and a set of non-overlapping symbols 314. The set of overlapping symbols 312 comprises 2 symbols 304, which in this case are symbols 8 and 9 in the slot 308. The set of non-overlapping symbols 314 comprises 4 symbols 304, which in this case are symbols 4 through 7. Assume the message 306 is assigned a higher priority in 5G NR. Based on this assumption, the UE transmits the entire set of 6 symbols 304 for the message 306, and it drops the 2 symbols 304 of the overlapping symbols 312 comprising symbol 8 and 9 from the SL PRS 230. However, the UE continues to transmit the non-overlapping symbols 314 of the SL PRS 230, which includes symbols 4 through 7, along with all 6 symbols 304 of the message 306.

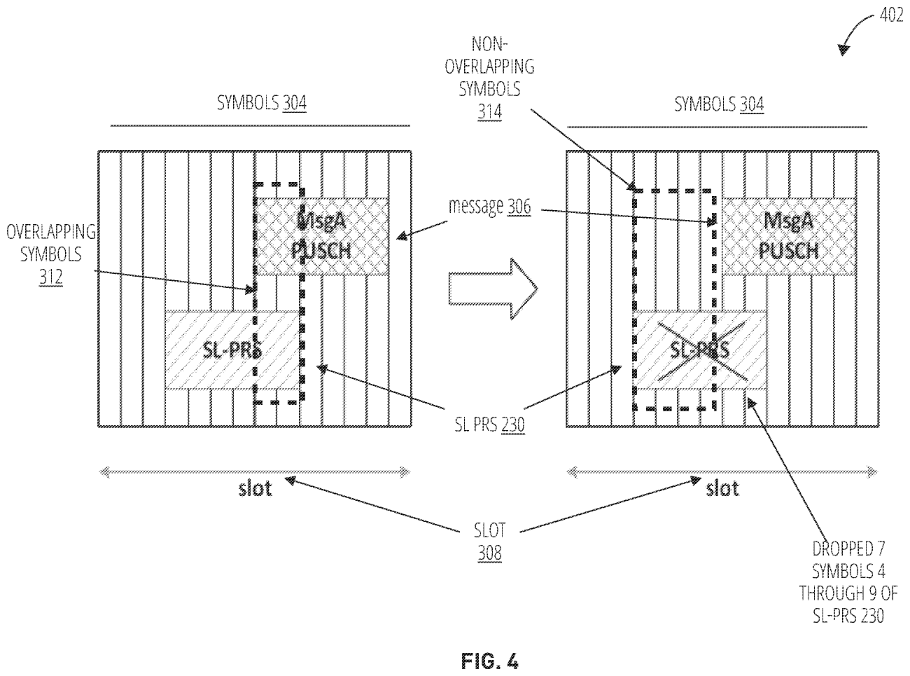

The operating environment 302 illustrates an example of a UE performing partial cancellation of the SL PRS 230 in the event of overlapping symbols 312. In another embodiment, the UE performs complete cancellation of the SL PRS 230 in the event of overlapping symbols 312. This scenario is illustrated in FIG. 4.

FIG. 4 illustrates and operating environment 402. The operating environment 402 illustrates one example of a complete cancellation of SL PRS 230 in overlapping symbols 312.

Assume one or more symbols for SL PRS 230 transmission or reception overlaps with sidelink transmission or reception, or an uplink transmission with a higher priority, in the time domain. If the UE is not capable of simultaneous transmission/reception of SL PRS 230 and sidelink transmission/reception or uplink transmission in a carrier or two carriers, the UE may decide to cancel or drop all the symbols 304 for the SL PRS 230 transmission or reception. Note that the symbols 304 may include the AGC symbol which is located prior to the SL PRS 230 transmission/reception and/or guard symbol which is located after the SL PRS 230 transmission/reception.

The operating environment 402 illustrates one example of cancellation of an entire SL PRS 230 transmission. As with the previous example discussed with reference to the operating environment 302, the operating environment 402 illustrates a case where the set of overlapping symbols 312 comprises 2 symbols 304, namely symbols 8 and 9, in the slot 308. In this case, given that the message 306 (e.g., MsgA PUSCH) has a higher priority relative to the SL PRS 230, the UE drops all 7 symbols 304 of the SL PRS 230 transmission, and it only transmits the 6 symbols 304 for the MsgA PUSCH.

The operating environment 302 and the operating environment 302 illustrate the message 306 as a MsgA PUSCH transmission. In another embodiment, assume the message 306 is one of a PRACH, Msg3 PUSCH initial transmission and retransmission, MsgA PUSCH, PUCCH carrying HARQ-ACK information of corresponding MsgB PDSCH transmission or a Msg4. In all these examples, further assume the message 306 has a higher priority than transmission or reception of an SL PRS 230. In this case, when the message 306 overlaps with transmission or reception of the SL PRS 230, and if the UE is not capable of simultaneous transmission/reception of SL PRS 230 and uplink transmission in a carrier or two carriers, the whole SL PRS 230 transmission or reception may be dropped or cancelled. Alternatively, the one or more overlapping symbols 312 of SL PRS 230 transmission or reception may be dropped or cancelled.

In another embodiment, a measurement gap may be configured for SL PRS 230 reception. During the measurement gap, the UE may only receive SL PRS 230 for sidelink positioning. The measurement gap may be configured in accordance with system frame duration, subframe duration, or physical slot.

In another embodiment, a measurement gap may be configured in accordance with logical indexing of slots configured for an SL PRS resource pool. More particularly, a measurement gap may be configured within an SL PRS resource pool for a dedicated SL PRS resource pool in which only SL PRS and possibly any associated PSCCH may be transmitted. Alternatively, a measurement gap may be configured in accordance with logical indexing of slots configured for sidelink communication resource pool when shared resource pool is configured for sidelink communication and SL PRS 230 transmission/measurement. Further, a measurement gap may be activated or deactivated via Medium Access Control-Control Element (MAC-CE) or sidelink control information (SCI) format.

In another embodiment, a SL PRS processing window may be provided to a UE for SL PRS 230 reception via higher layer (pre-) configuration and/or dynamic indication. In a further example, a UE may perform SL PRS 230 measurement outside a measurement gap, but within the SL PRS processing window.

The SL PRS processing window may be configured in accordance with the subframe index or physical slot index. In another option, the SL PRS processing window may be configured in accordance with the logical indexing of slots configured for the SL PRS resource pool when dedicated SL PRS resource pool is configured for SL PRS 230 transmission and measurement. Alternatively, the SL PRS processing window may be configured in accordance with the logic slot configured for the sidelink communication resource pool when shared resource pool is configured for sidelink communication and SL PRS 230 transmission/measurement.

Further, the SL PRS processing window may be activated or deactivated via Medium Access Control-Control Element (MAC-CE) or sidelink control information (SCI) format.

In addition, the UE may be configured with a priority parameter for SL PRS measurement by higher layer configuration. In one option, when a UE receives SL PRS 230 within a SL PRS processing window, and when the UE determines that SL PRS 230 has higher priority than sidelink physical channels/signals or uplink physical channels/signals, the UE is expected to receive SL PRS 230 and not expected to transmit or receive other sidelink physical channels/signals and/or transmit uplink physical channels/signals. Otherwise, the UE is not expected to measure the SL PRS 230 within the SL PRS processing window and expected to transmit or receive other sidelink physical channels/signals and/or transmit uplink physical channels/signals.

In some aspects, a UE may not be provided SL PRS processing window or measurement gap. In addition, the UE may be provided a priority value for an SL PRS 230 transmission or reception.

In another option, when a UE receives SL PRS 230 within a SL PRS processing window, and when the UE determines that SL PRS has higher priority than sidelink physical channels/signals or uplink physical channels/signals, the UE is expected to measure the SL PRS 230 and not expected to transmit or receive other sidelink physical channels/signals and/or transmit uplink physical channels/signals. Otherwise, the UE is not expected to measure the SL PRS 230 in the overlapped symbols 304 and expected to transmit or receive other sidelink physical channels/signals and/or transmit uplink physical channels/signals.

In another option, a UE may report the capability of supporting multiple priority states for SL PRS reception, such as 1 to 3 priority states. When one priority state supported, reception of SL PRS 230 and possibly PSCCH in a resource pool configured with SL PRS resources are of higher priority than any PSCCH, PSSCH, PSFCH, or SL-CSI-RS in another resource pool. When two priority states are supported, the two states are defined as: (1) State 1: reception of SL PRS 230 and possibly PSCCH in a resource pool configured with SL PRS resources are of higher priority than any PSCCH, PSSCH, PSFCH, or SL-CSI-RS; and (2) State 2: reception of SL PRS 230 and possibly PSCCH in a resource pool configured with SL PRS resources are of lower priority than any PSCCH, PSSCH, PSFCH, or SL-CSI-RS. When three priority states are supported, the three states are defined as: (1) State 1: reception of SL PRS 230 and possibly PSCCH in a resource pool configured with SL PRS resources are of higher priority than any PSCCH, PSSCH, PSFCH, or SL-CSI-RS in another resource pool; (2) State 2: reception of SL PRS 230 and possibly PSCCH in a resource pool configured with SL PRS resources are of lower priority than any Stage-1 PSCCCH and Stage-2 PSCCH, PSSCH, PSFCH with higher priority, and are of higher priority than any Stage-2 PSCCH, PSSCH, PSFCH not associated with high priority; and (3) State 3: reception of SL PRS 230 and possibly PSCCH in a resource pool configured with SL PRS resources are of lower priority than any PSCCH, PSSCH, PSFCH, or SL-CSI-RS. Based on the UE's capability, UE may be configured or pre-configured with one of the states if the UE may support either up to two or three priority states.

Embodiments of prioritization of SL PRS transmission or reception for sidelink positioning when no priority level is defined for SL-PTRS transmission or reception are provided as follows. In one embodiment, no priority level is defined for an SL PRS 230 transmission or reception. In this case, for prioritization between an SL PRS 230 transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 1, in one option, the UL transmission has higher priority than the SL PRS 230 transmission or reception. In another option, the SL PRS 230 transmission or reception has higher priority than the UL transmission.

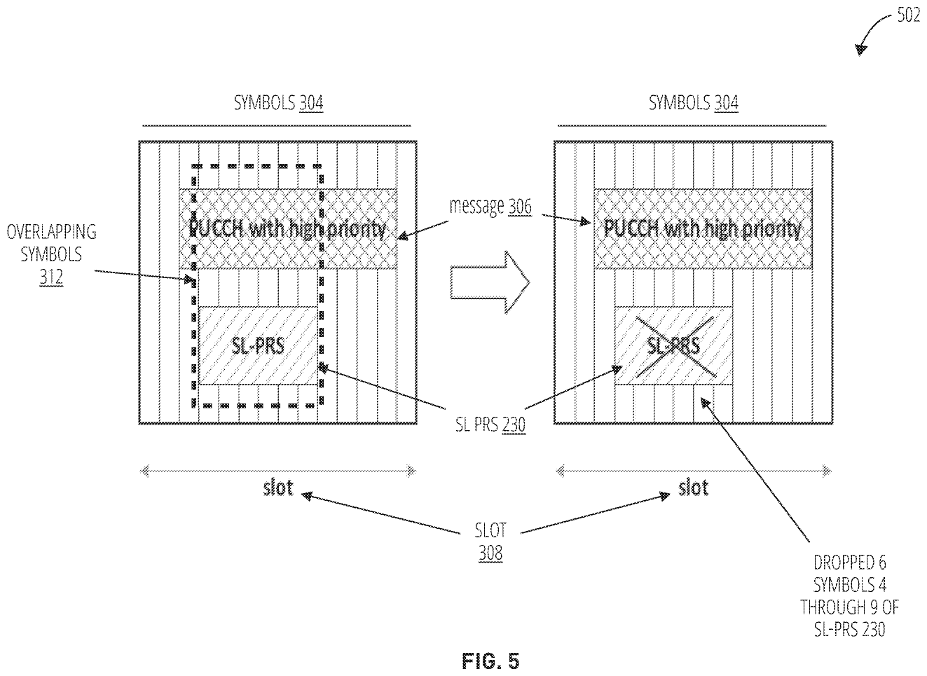

FIG. 5 illustrates an operating environment 502. The operating environment 502 illustrates one example of a complete cancellation of SL PRS 230 in overlapping symbols 312 with an uplink transmission with a higher priority than the SL PRS 230.

The operating environment 502 illustrates one example of prioritization of SL PRS 230 and an uplink transmission with a higher priority. In this example, assume the message 306 is a PUCCH transmission with a high priority level. The overlapping symbols 312 between the SL PRS 230 and a PUCCH transmission with high priority comprises all 6 symbols 304 of the SL PRS 230 in the slot 308. Based on the option as mentioned above, PUCCH transmission with a priority index 1 or high priority has a higher priority than the SL PRS 230 transmission. In this case, the UE drops all 6 symbols 304 of the SL PRS 230 transmission (symbols 4 to 9), and it only transmits the PUCCH transmission with the priority index 1 or higher priority.

Yet in another option, whether the UL transmission has higher priority than the SL PRS 230 transmission or reception or not can be configured or pre-configured by higher layers. In one example, when a parameter is configured, the UL transmission has higher priority than the SL PRS 230 transmission or reception. Otherwise, the SL PRS 230 transmission has higher priority than the UL transmission.

In another embodiment, no priority level is defined for an SL PRS 230 transmission or reception. In this case, for prioritization between an SL PRS 230 transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 0, in one option, the UL transmission has a higher priority than the SL PRS 230 transmission or reception. In another option, the SL PRS 230 transmission or reception has higher priority than the UL transmission.

Yet in another option, whether the UL transmission has higher priority than the SL PRS 230 transmission or reception or not can be configured or pre-configured by higher layers. In one example, when a parameter is configured, the UL transmission has higher priority than the SL PRS 230 transmission or reception. Otherwise, the SL PRS 230 transmission has higher priority than the UL transmission. Note that the parameter may be separately configured for UL transmission with priority index 0 and 1, respectively.

In another embodiment, no priority level is defined for an SL PRS 230 transmission or reception. In this case, for prioritization between an SL PRS 230 transmission/reception and a PUCCH or PUSCH transmission with a sidelink HARQ-ACK information report, the PUCCH transmission has higher priority than the SL PRS 230 transmission or reception if the priority value of the PUCCH transmission is smaller than a threshold, which can be configured or pre-configured by higher layers. Otherwise, the SL PRS 230 transmission has higher priority than the PUCCH transmission.

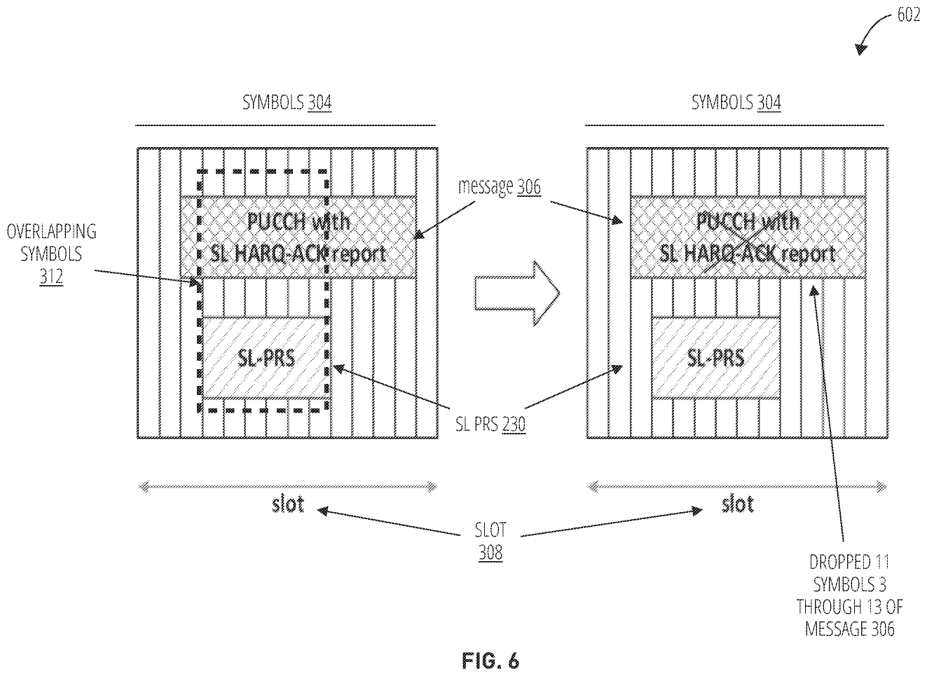

FIG. 6 illustrates an operating environment 602. The operating environment 602 illustrates one example of a complete transmission of SL PRS 230 in overlapping symbols 312 when the SL PRS 230 has a higher priority level than an uplink transmission having a lower priority than the SL PRS 230. As with the operating environment 502, the operating environment 602 illustrates a set of overlapping symbols 312 between the SL PRS 230 and a message 306 comprising all 6 symbols 304 of the SL PRS 230 in the slot 308.

The operating environment 602 illustrates one example of prioritization of SL PRS 230 over an uplink transmission with a lower priority. In this example, assume the message 306 is a PUCCH with SL HARQ-ACK report transmission with a lower priority level. In this example, assume the priority value of the PUCCH transmission is 4 and the UE is configured with a defined threshold with a value 3 for prioritization. Based on the option as mentioned above, the SL PRS 230 transmission has higher priority than the PUCCH transmission. In this case, all 11 symbols 304 of the PUCCH with SL HARQ-ACK report are dropped and the UE transmits all 6 symbols 304 of the SL PRS 230.

In another option, the PUCCH or PUSCH transmission with a sidelink HARQ-ACK information report always has higher priority than the SL PRS 230 transmission or reception. In another option, the SL PRS 230 transmission has higher priority than the PUCCH or PUSCH transmission with a sidelink HARQ-ACK information report.

Yet in another option, whether the PUCCH or PUSCH transmission with a sidelink HARQ-ACK information report has higher priority than the SL PRS 230 transmission or reception or not can be configured or pre-configured by higher layers.

In another embodiment, no priority level is defined for an SL PRS 230 transmission or reception. In this case, for prioritization between an SL PRS 230 transmission/reception and a SL transmission for SL communication including PSSCH/PSCCH, S-SS/PSBCH block and PSFCH, or a SL reception including S-SS/PSBCH block and PSFCH, the SL transmission or reception for SL communication has higher priority than the SL PRS 230 transmission or reception if a priority value of the SL transmission or reception for SL communication is smaller than a threshold, which can be configured or pre-configured by higher layers. Otherwise, the SL PRS 230 transmission has higher priority than the SL transmission or reception for SL communication.

In another option, the SL transmission or reception for SL communication always has higher priority than the SL PRS 230 transmission or reception. In another option, the SL PRS 230 transmission has higher priority than the SL transmission or reception for SL communication.

Yet in another option, whether the SL transmission or reception for SL communication has higher priority than the SL PRS 230 transmission or reception or not can be configured or pre-configured by higher layers.

Embodiments of prioritization of SL PRS 230 transmission or reception for sidelink positioning when priority level is defined for SL PRS 230 transmission or reception are provided as follows. In one embodiment, one or more than one priority may be defined for the transmission/reception of SL PRS 230 for sidelink positioning. Further, one field may be included in the first stage (1^{st} stage) or second stage (2^{nd} stage) SCI format to indicate the priority value for SL PRS 230 transmission. Note that this can be applied for the mode 1 and/or mode 2 resource allocation for SL PRS 230.

In one example, two priority values can be defined for SL PRS 230 transmission and reception. In this case, one bit field can be included in the 1^{st} stage SCI format. In particular, bit “1” may indicate that the SL PRS 230 transmission has high priority while bit “0” may indica indicate that the SL PRS 230 transmission has low priority.

In another embodiment, when one or more than one priority value is defined for SL PRS 230 transmission and/or reception, for prioritization between an SL PRS 230 transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 1, when the priority value of the SL PRS 230 transmission or reception is smaller than a priority threshold, which can be configured or pre-configured by higher layers, the SL PRS 230 transmission or reception has higher priority than the UL transmission; otherwise, the UL transmission has higher priority than the SL PRS 230 transmission or reception.

If a priority threshold is not configured for an SL PRS 230 transmission, an UL transmission has higher priority than the SL PRS 230 transmission or reception.

In another option, an UL transmission always has higher priority than the SL PRS 230 transmission or reception. In another option, the SL PRS 230 transmission or reception always has higher priority than the UL transmission.

Yet in another option, whether the UL transmission has higher priority than the SL PRS 230 transmission or reception or not can be configured or pre-configured by higher layers. In one example, when a parameter is configured, the UL transmission has higher priority than the SL PRS 230 transmission or reception. Otherwise, the SL PRS transmission has higher priority than the UL transmission.

In another embodiment, when one or more than one priority value is defined for SL PRS 230 transmission and/or reception, for prioritization between an SL PRS 230 transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 0, when the priority value of the SL PRS 230 transmission or reception is smaller than a priority threshold, which can be configured or pre-configured by higher layers, the SL PRS 230 transmission or reception has higher priority than the UL transmission; otherwise, the UL transmission has higher priority than the SL PRS 230 transmission or reception. Note that the priority threshold may be separately configured for UL transmission with priority index 0 and 1, respectively.

If the priority threshold is not configured, the UL transmission has higher priority than the SL PRS 230 transmission or reception.

In another option, the UL transmission always has higher priority than the SL PRS 230 transmission or reception. In another option, the SL PRS 230 transmission or reception always has higher priority than the UL transmission.

Yet in another option, whether the UL transmission has higher priority than the SL PRS 230 transmission or reception or not can be configured or pre-configured by higher layers. In one example, when a parameter is configured, the UL transmission has higher priority than the SL PRS 230 transmission or reception. Otherwise, the SL PRS 230 transmission has a higher priority than the UL transmission.

In another embodiment, when one or more than one priority value is defined for SL PRS 230 transmission and/or reception, for prioritization between an SL PRS 230 transmission/reception and a PUCCH or PUSCH transmission with a sidelink HARQ-ACK information report, the PUCCH or PUSCH transmission has a higher priority than the SL PRS 230 transmission or reception if a priority value of the PUCCH or PUSCH transmission is smaller than a priority value of the SL PRS 230 transmission or reception; otherwise, the SL PRS 230 transmission or reception has higher priority than the PUCCH or PUSCH transmission.

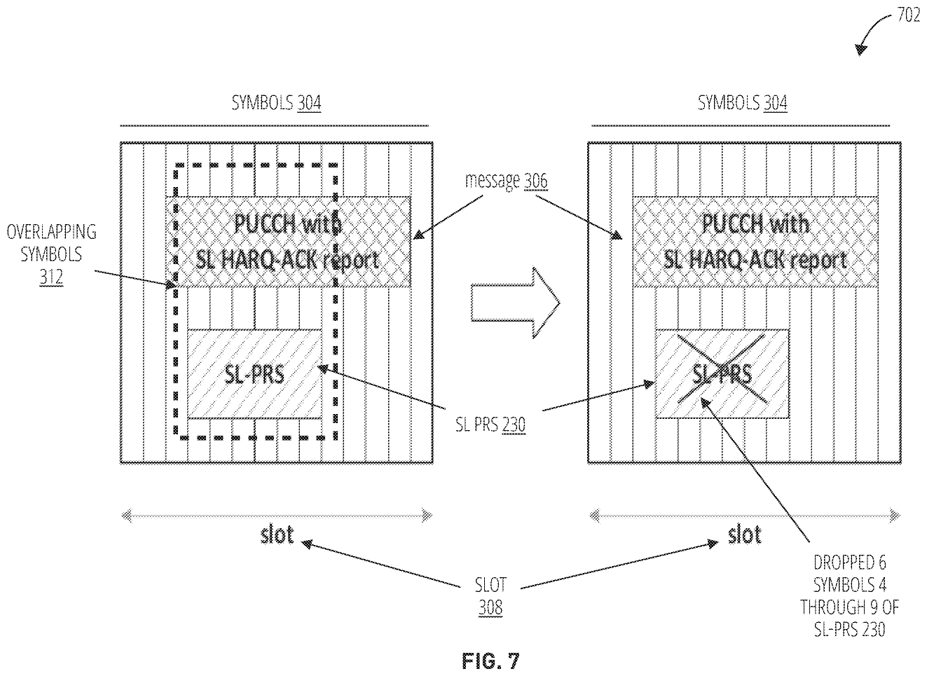

FIG. 7 illustrates an operating environment 702. The operating environment 702 illustrates one example of a complete cancellation of SL PRS 230 in overlapping symbols 312 when the SL PRS 230 has a lower priority level than an uplink transmission having a higher priority than the SL PRS 230. As with the operating environment 602, the operating environment 702 illustrates a set of overlapping symbols 312 between the SL PRS 230 and a message 306 comprising all 6 symbols 304 of the SL PRS 230 in the slot 308.

Assume the message 306 is a PUCCH with SL HARQ-ACK report. FIG. 7 illustrates one example of prioritization of SL PRS 230 and the PUCCH with SL HARQ-ACK report when more than one priority value is defined for the SL PRS 230. In this example, the priority value of the PUCCH transmission is set to a priority level 2 and the priority value of the SL PRS 230 transmission is set to a priority level of 3. Based on the option as mentioned above, the PUCCH transmission has higher priority than the SL PRS 230 transmission. In this case, all 6 symbols 304 of the SL PRS 230 are dropped, and the UE transmits all 11 symbols 304 of the PUCCH with SL HARQ-ACK report.

In another embodiment, when one or more than one priority value is defined for SL PRS 230 transmission and/or reception, for prioritization between an SL PRS 230 transmission/reception and a SL transmission for SL communication including PSSCH/PSCCH, S-SS/PSBCH block and PSFCH, or a SL reception including S-SS/PSBCH block and PSFCH, the SL transmission or reception for SL communication has higher priority than the SL PRS 230 transmission or reception if a priority value of the SL transmission or reception for SL communication is smaller than a priority value of the SL PRS 230 transmission or reception; otherwise, the SL PRS 230 transmission has higher priority than the SL transmission or reception for SL communication.

In another option, the SL transmission or reception for SL communication always has higher priority than the SL PRS 230 transmission or reception. In another option, the SL PRS 230 transmission has higher priority than the SL transmission or reception for SL communication.

Yet in another option, whether the SL transmission or reception for SL communication has higher priority than the SL PRS 230 transmission or reception or not can be configured or pre-configured by higher layers or indicated by SCI format.

In some aspects, the above embodiments may apply for one of or both shared resource pool for SL communication and SL positioning, and dedicated resource pool for SL PRS 230.

In another embodiment, in case of a shared resource pool for SL communication and SL positioning, the value of priority field that is indicated in the 1^{st} stage SCI may be determined in accordance with a function of priority value for SL communication and priority value for SL PRS 230.

In some aspects, this may apply for the case when both PSSCH and SL PRS 230 are scheduled in the shared resource pool.

In one example, the value of priority field that is indicated in the 1^{st} stage SCI may correspond to the higher of the priority value for SL communication and the priority value for SL PRS 230.

In another option, when SL PRS 230 is not scheduled in the shared resource pool and the 1^{st} stage SCI indicates a new 2^{nd} stage SCI format associated with SL PRS 230 scheduling, the value of priority field that is indicated in the 1^{st} stage SCI may correspond to the priority value for SL communication.

In another option, when SL PRS 230 is scheduled but PSSCH carrying SL-SCH is not scheduled in the shared resource pool, the value of priority field that is indicated in the 1^{st} stage SCI may correspond to the priority value for SL PRS 230.

In another option, for shared resource pool, priority field may be included in the 2^{nd} stage SCI, which may be used to schedule SL PRS 230 transmission. In some aspects, this new 2^{nd} stage SCI format may be indicated using code point of “11” in the 1^{st} stage SCI. In addition, the value of priority field may correspond to the priority value for SL PRS 230.

In another option, if SL PRS 230 may be multiplexed within a slot that is indicated by a SL resource grant after resource selection, then the priority value indicated in the 1^{st} stage SCI may correspond to the priority value for SL communication.

As a further extension, when SL PRS 230 is not scheduled in the shared resource pool, priority field may still be present in the 2^{nd} stage SCI. In this case, the receiving UE may ignore the priority field in the 2^{nd} stage SCI.

In another embodiment, for a dedicated resource pool, when only PSCCH and SL PRS 230 are included, priority field may be included in a single SCI format, where the value of priority field may correspond to the priority value for SL PRS 230.

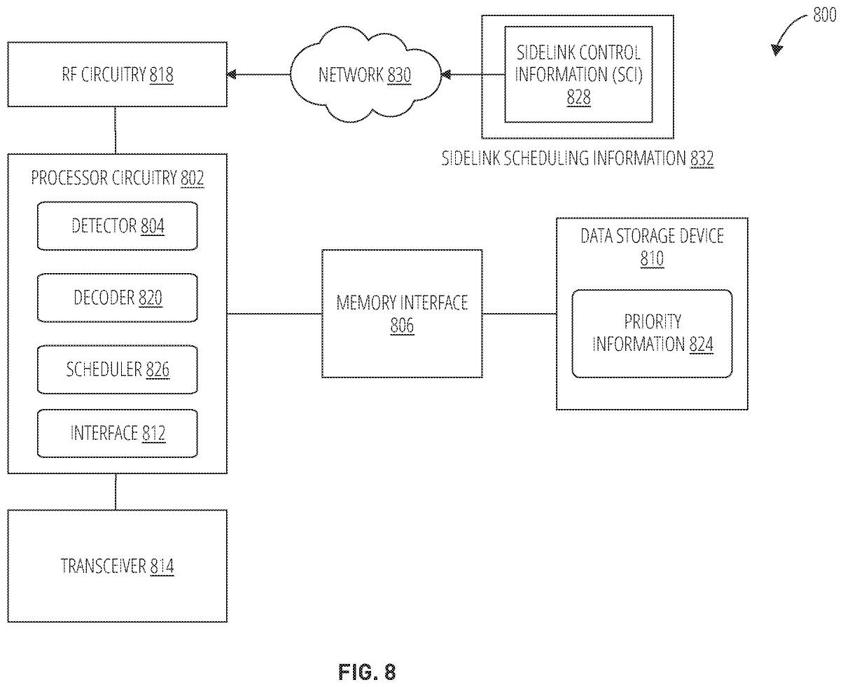

FIG. 8 illustrates an apparatus 800 suitable for implementing any logic supporting embodiments as described herein. In one embodiment, for example, the apparatus 800 is implemented by a UE, such as an anchor UE 222 or a target UE 220 in a V2V or V2X network.

As depicted in FIG. 8, the apparatus 800 for a user equipment (UE) includes a memory interface 806 to send or receive, to or from a data storage device 810, priority information 824 to schedule transmission or reception of an SL PRS 230 in a NR system, such as the wireless communications system 100 or the wireless communications system 200. The apparatus 800 also includes processor circuitry 802 communicatively coupled to the memory interface 806. The processor circuitry 802 implements logic for a detector 804, a decoder 820, and a scheduler 826. The detector 804 operates to detect a set of overlapping symbols 312 between the SL PRS 230 and a message 306 in a slot 308 for a frame in a time domain of the NR system. In one embodiment, the message 306 includes data for a SL transmission or an UL transmission. The decoder 820 decodes the priority information 824 for the SL PRS 230 from SCI 828, and it stores the priority information 824 in the data storage device 810 for subsequent retrieval from the data storage device 810. The scheduler 826 determines a schedule for transmission or reception of the SL PRS 230 and the message 306 based on the priority information 824 for the SL PRS 230. The processor circuitry 802 sends an indication to transmit or receive the SL PRS 230 or the message 306 to radio-frequency (RF) RF circuitry 818 via an interface 812 in accordance with the schedule. The RF circuitry 818 transmits or receives the SL PRS 230 and/or the message 306 as RF signals over the wireless communications system 100 or the wireless communications system 200.

In one embodiment, the priority information 824 comprises priority information for the SL PRS 230, the message 306, or both the SL PRS 230 and the message 306. The priority information 824 may comprise a defined priority level in a defined priority scheme for the wireless communications system 100 or the wireless communications system 200. The priority information 824 may also include defined threshold values for the defined priority levels. The scheduler 826 may compare the priority values for either the SL PRS 230 or the message 306 to the defined threshold values, and it schedules transmission or reception of the SL PRS 230 or the message 306 based on comparison results.

The apparatus 800 may also include the scheduler 826 of the processor circuitry 802 to determine the SL PRS 230 has a lower priority and the message 306 has a higher priority based on the priority information 824. The scheduler 826 then schedules the message 306 with the higher priority for transmission or reception. The scheduler 826 drops or cancels the set of overlapping symbols 312 for the SL PRS 230 with a lower priority. The scheduler 826 schedules a set of non-overlapping symbols 314 for the SL PRS 230 for transmission or reception over the RF circuitry 818.

The apparatus 800 may also include the scheduler 826 of the processor circuitry 802 to determine the SL PRS 230 has a lower priority and the message 306 has a higher priority based on the priority information 824. In this case, the scheduler 826 schedules the message 306 with the higher priority for transmission or reception over the RF circuitry 818. The scheduler 826 also schedules to drop or cancel all the symbols 304 for the SL PRS 230 with a lower priority.

The apparatus 800 may also include the scheduler 826 of the processor circuitry 802 to determine the SL PRS 230 has a higher priority and the message 306 has a lower priority based on the priority information 824. The scheduler 826 schedules the SL PRS 230 with the higher priority for transmission or reception over the RF circuitry 818. The scheduler 826 also schedules to drop all the symbols 304 for the message 306 with a lower priority.

The apparatus 800 may also include the scheduler 826 of the processor circuitry 802 to determine the SL PRS 230 does not have a priority level, either based on the priority information 824 or through absence of the priority information 824 in the data storage device 810. The scheduler 826 schedules the message 306 for transmission or reception by the RF circuitry 818 as a default priority setting.

The apparatus 800 may also include the decoder 820 of the processor circuitry 802 to decode sidelink scheduling information 832 for the SL PRS 230 from SCI 828 in a first stage (1st-stage) SCI format carried on a physical sidelink control channel (PSCCH) or a second stage (2nd-stage) SCI format carried on a physical sidelink shared channel (PSSCH). In one embodiment, one or more information fields for the 1st-stage SCI format or the 2nd-stage SCI format indicates the priority information 824 for the SL PRS 230. The decoder 820 decodes data from the PSCCH or the PSSCH, and it retrieves the priority information 824 from the information field. The decoder 820 then stores the priority information 824 in the data storage device 810 of the apparatus 800.

The apparatus 800 may also include the decoder 820 of the processor circuitry 802 to decode sidelink scheduling information 832 for the SL PRS 230 from the SCI 828 in a first stage (1st-stage) SCI format 1-B carried on a physical sidelink control channel (PSCCH). In one embodiment, for example, the SCI format 1-B includes information fields for a priority, a source identifier (ID), a destination ID, a cast type indicator, or a resource reservation period N_{rsv-period}, where the N_{rsv-period} is a number of entries in a higher layer parameter sl-PRSResourceReservePeriodList, if a higher layer parameter sl-PRSResourceReservePeriodList is configured; and a 0 bit otherwise.

The apparatus 800 may also include the decoder 820 of the processor circuitry 802 to decode sidelink scheduling information 832 for the SL PRS 230 from the SCI 828 in a second stage (2nd-stage) SCI format 2-D carried on a physical sidelink shared channel (PSSCH). In one embodiment, for example, the SCI format 2-D includes information fields for a hybrid automatic repeat request (HARQ) process number includes 4 bits, a new data indicator includes 1 bit, a redundancy version includes 2 bits, a source identifier (ID) comprise 8 bits, a destination ID includes 16 bits, or a HARQ feedback enabled/disabled indicator includes 1 bit.

As previously described with reference to FIG. 1, various embodiments discussed herein may be implemented in a wireless communications system as defined by the 3GPP TS 38.212 titled “Technical Specification Group Radio Access Network; NR; Multiplexing and channel coding,” Release 17.5.0, March 2023 (“3GPP TS 38.212”); and 3GPP TS 38.213 titled “Technical Specification Group Radio Access Network; NR; Physical layer procedures for control,” Release 17.6.0, June 2023 (“3GPP TS 28.213); both including any progeny, revisions or variants. It may be appreciated that the embodiments may be implemented in accordance with other 3GPP TS, TR and WI, as well as other wireless standards released by other standards entities. Embodiments are not limited in this context.

With respect to 3GPP TS 38.212, for example, embodiments may be implemented as part of 3GPP TS 38.212 Release 18. By way of example and not limitation, the embodiments may be implemented in 3GPP TS 38.212, Release 18, section 8.3.1.2 titled “SCI format 1-B” and section 8.4.1.4 titled “SCI format 2-D,” among other sections of 3GPP TS 38.212, Release 18. Section 8.4 titled “Sidelink control information on PSSCH” with the proposed section 8.3.1.2 is reproduced as follows:

8.3.1.2 SCI format 1-B

SCI format 1-B is used for the scheduling of SL PRS.

The following information is transmitted by means of the SCI format 1-B:
Priority—x bits as specified in clause x.x of [12, TS 23.287] and clause x.x of [8, TS 38.321].
Source ID—x bits as defined in clause x.x of [6, TS 38.214].
Destination ID—x bits as defined in clause x.x of [6, TS 38.214].
Cast type indicator—2 bits as defined in clause x.x of [6, TS 38.214].
Resource reservation period—[log₂N_{rsv-period}] bits as defined in clause xx of [5, TS 38.213], where N_{rsv-period} is the number of entries in the higher layer parameter sl-PRSResourceReservePeriodList, if higher layer parameter sl-PRSResourceReservePeriodList is configured; 0 bit otherwise.

Section 8.4 titled “Sidelink control information on PSSCH” with the proposed section 8.4.1.4 is reproduced as follows:

8.4.1.4 SCI format 2-D

SCI format 2-D is used for the decoding of PSSCH and the scheduling of SL PRS.

The following information is transmitted by means of the SCI format 2-D:
HARQ process number—bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

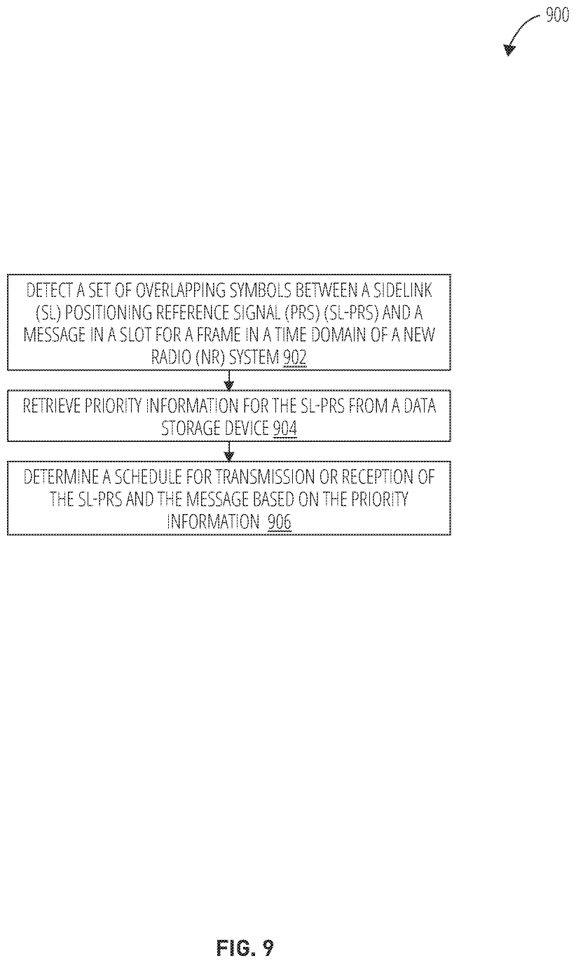

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the wireless communications system 100 or the wireless communications system 200, such as the apparatus 800. Embodiments are not limited in this context.

In block 902, logic flow 900 detects a set of overlapping symbols between a sidelink (SL) positioning reference signal (PRS) (SL PRS) and a message in a slot for a frame in a time domain of a new radio (NR) system. For example, the detector 804 of the processor circuitry 802 of the apparatus 800 detects a set of overlapping symbols between an SL PRS 230 and a message 306 in a slot 308 for a frame in a time domain of a NR system, such as the wireless communications system 100 or the wireless communications system 200. The message 306 may comprise data for a SL communication or an UL communication.

In block 904, logic flow 900 retrieves priority information for the SL PRS from a data storage device. For example, the scheduler 826 of the processor circuitry 802 of the apparatus 800 retrieves priority information 824 for the SL PRS 230 from the data storage device 810.

In block 906, logic flow 900 determines a schedule for transmission or reception of the SL PRS and the message based on the priority information. For example, the scheduler 826 determines a schedule for transmission or reception of the SL PRS 230 and the message 306 based on the priority information 824.

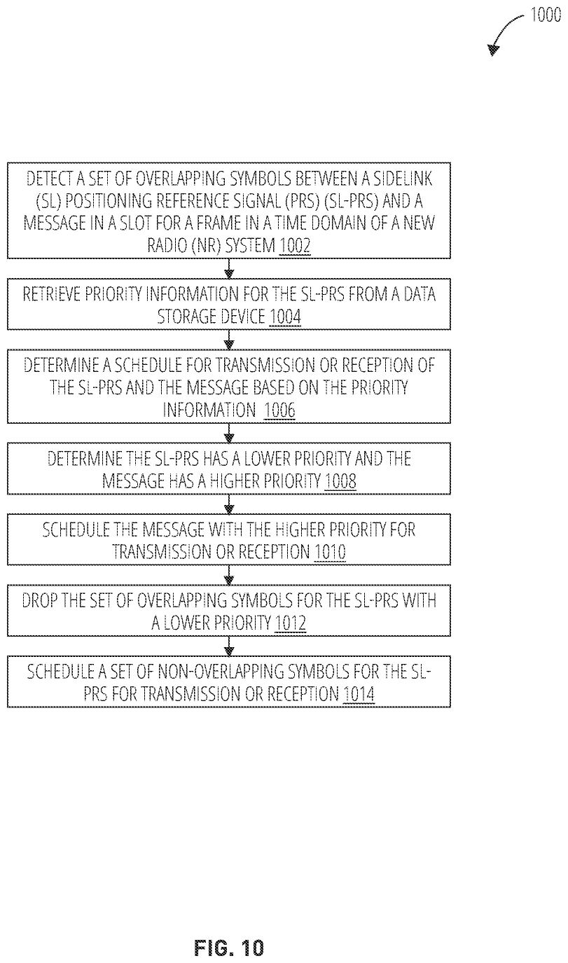

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the wireless communications system 100 or the wireless communications system 200, such as the apparatus 800. Embodiments are not limited in this context.

In block 1002, logic flow 1000 detects a set of overlapping symbols between a sidelink (SL) positioning reference signal (PRS) (SL PRS) and a message in a slot for a frame in a time domain of a new radio (NR) system. In block 1004, logic flow 1000 retrieves priority information for the SL PRS from a data storage device. In block 1006, logic flow 1000 determines a schedule for transmission or reception of the SL PRS and the message based on the priority information. Examples for block 1002, block 1004, and block 1006 are similar to those given for block 902, block 904, and block 906 of the logic flow 900, respectively.

In block 1008, logic flow 1000 determines the SL PRS has a lower priority and the message has a higher priority. For example, the scheduler 826 determines the SL PRS 230 has a lower priority and the message has a higher priority based on the priority information 824.

In block 1010, logic flow 1000 schedules the message with the higher priority for transmission or reception. For example, the scheduler 826 schedules the message 306 with the higher priority for transmission or reception via the RF circuitry 818.

In block 1012, logic flow 1000 drops the set of overlapping symbols for the SL PRS with a lower priority. For example, the scheduler 826 schedules the SL PRS 230 to drop the set of overlapping symbols 312 for the SL PRS 230 with a lower priority.

In block 1014, logic flow 1000 schedules a set of non-overlapping symbols for the SL PRS for transmission or reception. For example, the scheduler 826 schedules a set of non-overlapping symbols 314 for the SL PRS 230 for transmission or reception via the RF circuitry 818.

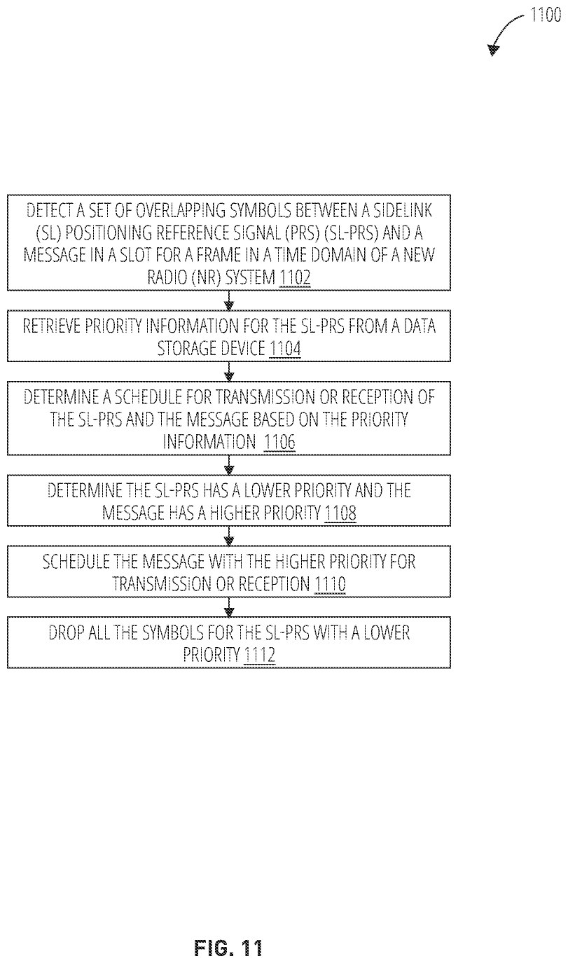

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the wireless communications system 100 or the wireless communications system 200, such as the apparatus 800. Embodiments are not limited in this context.

In block 1102, logic flow 1100 detects a set of overlapping symbols between a sidelink (SL) positioning reference signal (PRS) (SL PRS) and a message in a slot for a frame in a time domain of a new radio (NR) system. In block 1104, logic flow 1100 retrieves priority information for the SL PRS from a data storage device. In block 1106, logic flow 1100 determines a schedule for transmission or reception of the SL PRS and the message based on the priority information. Examples for block 1102, block 1104, and block 1106 are similar to those given for block 902, block 904, and block 906 of the logic flow 900, respectively.

In block 1108, logic flow 1100 determines the SL PRS has a lower priority and the message has a higher priority. For example, the scheduler 826 determines the SL PRS 230 has a lower priority and the message 306 has a higher priority based on the priority information 824.

In block 1110, logic flow 1100 schedules the message with the higher priority for transmission or reception. For example, the scheduler 826 schedules the message 306 with the higher priority for transmission or reception via the RF circuitry 818.

In block 1112, logic flow 1100 drops all the symbols for the SL PRS with a lower priority. For example, the scheduler 826 schedules the SL PRS 230 to drop all the symbols 304 for the SL PRS 230 with a lower priority.

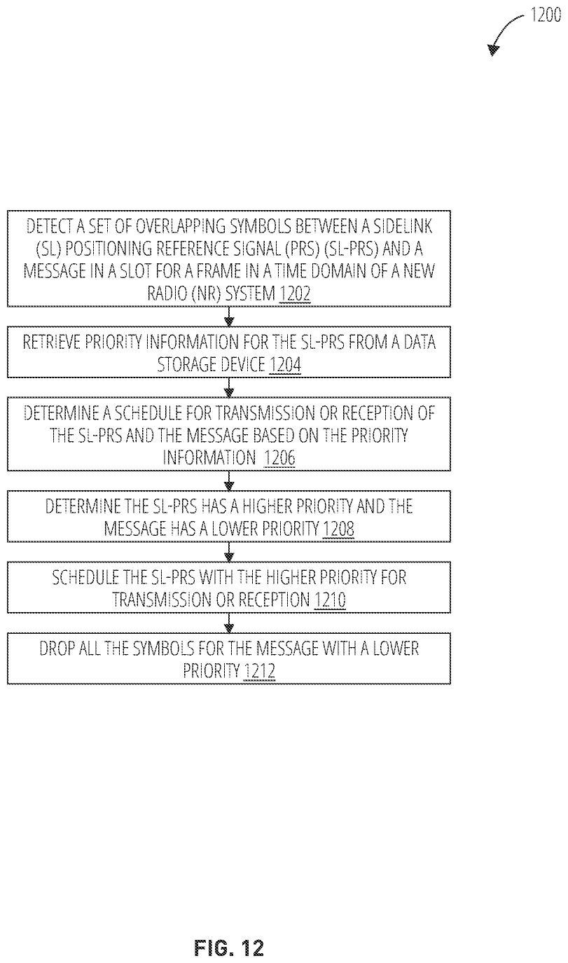

FIG. 12 illustrates an embodiment of a logic flow 1200. The logic flow 1200 may be representative of some or all of the operations executed by one or more embodiments described herein. For example, the logic flow 1200 may include some or all of the operations performed by devices or entities within the wireless communications system 100 or the wireless communications system 200, such as the apparatus 800. Embodiments are not limited in this context.

In block 1202, logic flow 1200 detects a set of overlapping symbols between a sidelink (SL) positioning reference signal (PRS) (SL PRS) and a message in a slot for a frame in a time domain of a new radio (NR) system. In block 1204, logic flow 1200 retrieves priority information for the SL PRS from a data storage device. In block 1206, logic flow 1200 determines a schedule for transmission or reception of the SL PRS and the message based on the priority information. Examples for block 1202, block 1204, and block 1206 are similar to those given for block 902, block 904, and block 906 of the logic flow 900, respectively.

In block 1208, logic flow 1200 determines the SL PRS has a higher priority and the message has a lower priority. For example, the scheduler 826 determines the SL PRS 230 has a higher priority and the message 306 has a lower priority based on the priority information 824.

In block 1210, logic flow 1200 schedules the SL PRS with the higher priority for transmission or reception. For example, the scheduler 826 schedules the SL PRS 230 with the higher priority for transmission or reception via the RF circuitry 818.

In block 1212, logic flow 1200 drops all the symbols for the message with a lower priority. For example, the scheduler 826 schedules the SL PRS 230 to drop all the symbols 304 for the message 306 with a lower priority.

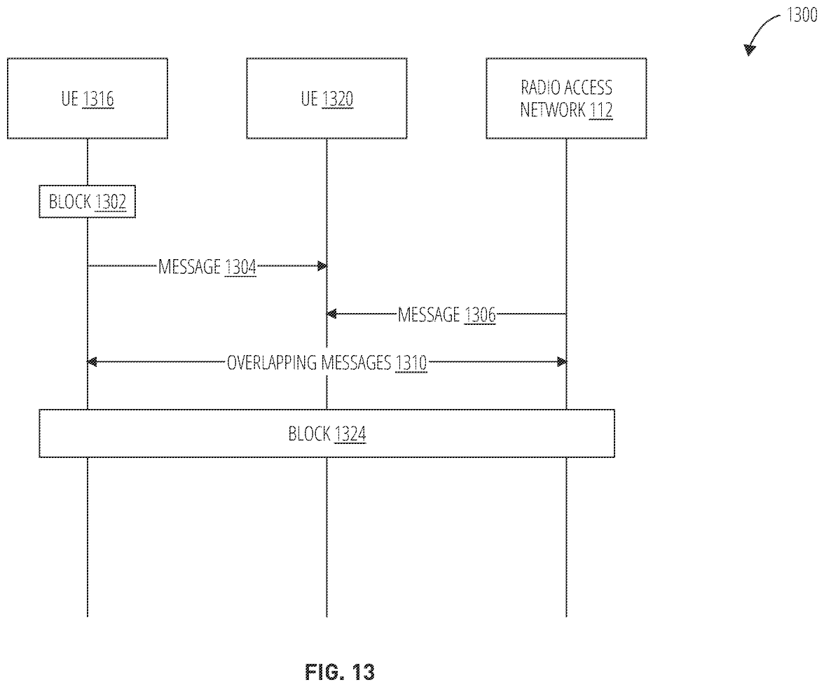

FIG. 13 illustrates a message flow 1300. The message flow 1300 provides an example of messages to support the logic flow 900, logic flow 1000, logic flow 1100, or the logic flow 1200 in a NR system, such as the wireless communications system 100 or the wireless communications system 200.

As depicted in FIG. 13, a UE 1316 generates information suitable for an SL PRS 230 at block 1302. For example, assume the UE 1316 is an anchor UE 222. The UE 1316 sends a message 1304 which is the SL PRS 230 to a UE 1320, which is implemented as the target UE 220. At some time before or after the UE 1320 receives the message 1304, assume the RAN 1318 generates information suitable for sidelink scheduling information 832, and it sends a message 1306 with the sidelink scheduling information 832. The UE 1320 decodes the sidelink scheduling information 832 from the message 1306, and it stores it in the data storage device 810 of the apparatus 800.

At some point, the UE 1320 decides to transmit a set of overlapping messages 1310, with a first message 1310 comprising a SL communication to the UE 1316 and a second message 1310 comprising an UL communication to the RAN 1318. The SL communication may comprise an SL PRS 230 or another type of SL communication. Assume the first message and the second message have overlapping symbols 312 in a physical slot 308 of a subframe of a frame for SL communications. The UE 1320 implements priority techniques as described with reference to logic flow 900, logic flow 1000, logic flow 1100 or logic flow 1200 to determine whether the first message or the second message has a higher priority level or a lower priority level relative to each other. At block 1324, the UE 1320 schedules transmission of the first message or the second message based on a given priority technique. For example, the UE 1320 schedules to transmit some or all of the symbols 304 of the first message, transmit some or all of the symbols 304 of the second message, cancel some or all of the symbols 304 of the first message, or cancel some or all of the symbols 304 of the second message.

The message flow 1300 may also be applied to conflicting receptions of messages as well as transmission of messages. Embodiments are not limited to a particular message direction, priority scheme or a number of symbols 304 to communicate or cancel.

FIGS. 10-13 illustrate various systems, devices and components that may implement aspects of disclosed embodiments. The systems, devices, and components may be the same, or similar to, the systems, device and components described with reference to FIG. 1.

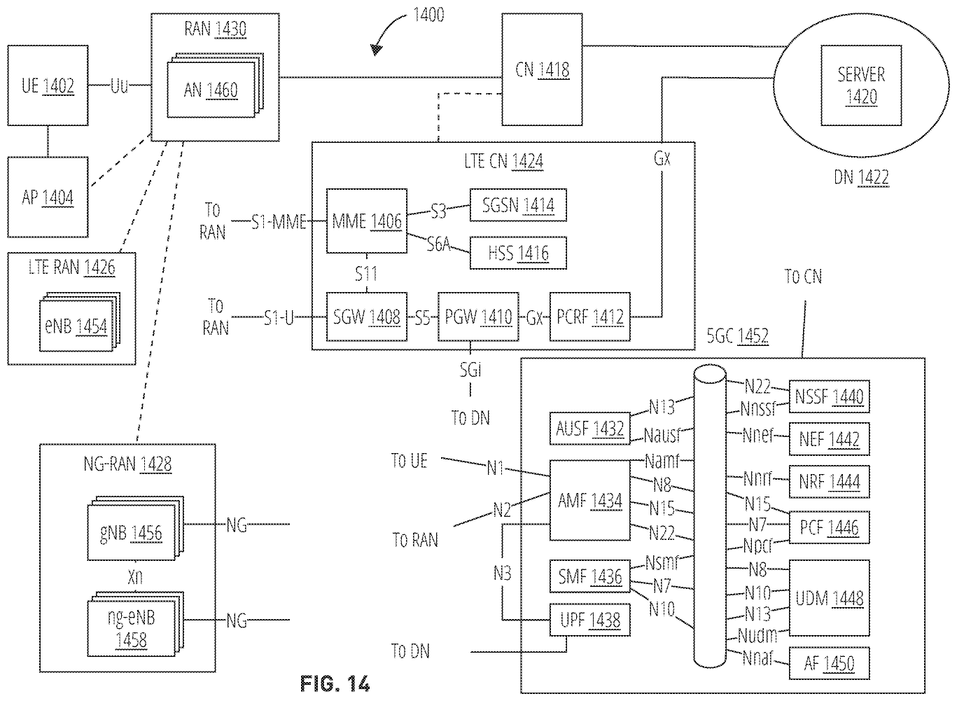

FIG. 14 illustrates a network 1400 in accordance with various embodiments. The network 1400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1400 may include a UE 1402, which may include any mobile or non-mobile computing device designed to communicate with a RAN 1430 via an over-the-air connection. The UE 1402 may be communicatively coupled with the RAN 1430 by a Uu interface. The UE 1402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1402 may additionally communicate with an AP 1404 via an over-the-air connection. The AP 1404 may manage a WLAN connection, which may serve to offload some/all network traffic from the RAN 1430. The connection between the UE 1402 and the AP 1404 may be consistent with any IEEE 1402.11 protocol, wherein the AP 1404 could be a wireless fidelity (Wi-Fi®) router. In some embodiments, the UE 1402, RAN 1430, and AP 1404 may utilize cellular-WLAN aggregation (for example, LWA/LWIP). Cellular-WLAN aggregation may involve the UE 1402 being configured by the RAN 1430 to utilize both cellular radio resources and WLAN resources.

The RAN 1430 may include one or more access nodes, for example, AN 1460. AN 1460 may terminate air-interface protocols for the UE 1402 by providing access stratum protocols including RRC, PDCP, RLC, MAC, and L1 protocols. In this manner, the AN 1460 may enable data/voice connectivity between CN 1418 and the UE 1402. In some embodiments, the AN 1460 may be implemented in a discrete device or as one or more software entities running on server computers as part of, for example, a virtual network, which may be referred to as a CRAN or virtual baseband unit pool. The AN 1460 be referred to as a BS, gNB, RAN node, eNB, ng-eNB, NodeB, RSU, TRxP, TRP, etc. The AN 1460 may be a macrocell base station or a low power base station for providing femtocells, picocells or other like cells having smaller coverage areas, smaller user capacity, or higher bandwidth compared to macrocells.

In embodiments in which the RAN 1430 includes a plurality of ANs, they may be coupled with one another via an X2 interface (if the RAN 1430 is an LTE RAN) or an Xn interface (if the RAN 1430 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1430 may each manage one or more cells, cell groups, component carriers, etc. to provide the UE 1402 with an air interface for network access. The UE 1402 may be simultaneously connected with a plurality of cells provided by the same or different ANs of the RAN 1430. For example, the UE 1402 and RAN 1430 may use carrier aggregation to allow the UE 1402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1430 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1402 or AN 1460 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally, or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1430 may be an LTE RAN 1426 with eNBs, for example, eNB 1454. The LTE RAN 1426 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 1430 may be an NG-RAN 1428 with gNBs, for example, gNB 1456, or ng-eNBs, for example, ng-eNB 1458. The gNB 1456 may connect with 5G-enabled UEs using a 5G NR interface. The gNB 1456 may connect with a 5G core through an NG interface, which may include an N2 interface or an N3 interface. The ng-eNB 1458 may also connect with the 5G core through an NG interface, but may connect with a UE via an LTE air interface. The gNB 1456 and the ng-eNB 1458 may connect with each other over an Xn interface.

In some embodiments, the NG interface may be split into two parts, an NG user plane (NG-U) interface, which carries traffic data between the nodes of the NG-RAN 1428 and a UPF 1438 (e.g., N3 interface), and an NG control plane (NG-C) interface, which is a signaling interface between the nodes of the NG-RAN 1428 and an AMF 1434 (e.g., N2 interface).

The NG-RAN 1428 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1402 can be configured with multiple BWPs where each BWP configuration has a different SCS. When a BWP change is indicated to the UE 1402, the SCS of the transmission is changed as well. Another use case example of BWP is related to power saving. In particular, multiple BWPs can be configured for the UE 1402 with different amount of frequency resources (for example, PRBs) to support data transmission under different traffic loading scenarios. A BWP containing a smaller number of PRBs can be used for data transmission with small traffic load while allowing power saving at the UE 1402 and in some cases at the gNB 1456. A BWP containing a larger number of PRBs can be used for scenarios with higher traffic load.

The RAN 1430 is communicatively coupled to CN 1418 that includes network elements to provide various functions to support data and telecommunications services to customers/subscribers (for example, users of UE 1402). The components of the CN 1418 may be implemented in one physical node or separate physical nodes. In some embodiments, NFV may be utilized to virtualize any or all of the functions provided by the network elements of the CN 1418 onto physical compute/storage resources in servers, switches, etc. A logical instantiation of the CN 1418 may be referred to as a network slice, and a logical instantiation of a portion of the CN 1418 may be referred to as a network sub-slice.

In some embodiments, the CN 1418 may be an LTE CN 1424, which may also be referred to as an EPC. The LTE CN 1424 may include MME 1406, SGW 1408, SGSN 1414, HSS 1416, PGW 1410, and PCRF 1412 coupled with one another over interfaces (or “reference points”) as shown. Functions of the elements of the LTE CN 1424 may be briefly introduced as follows.

The MME 1406 may implement mobility management functions to track a current location of the UE 1402 to facilitate paging, bearer activation/deactivation, handovers, gateway selection, authentication, etc.

The SGW 1408 may terminate an S1 interface toward the RAN and route data packets between the RAN and the LTE CN 1424. The SGW 1408 may be a local mobility anchor point for inter-RAN node handovers and also may provide an anchor for inter-3GPP mobility. Other responsibilities may include lawful intercept, charging, and some policy enforcement.

The SGSN 1414 may track a location of the UE 1402 and perform security functions and access control. In addition, the SGSN 1414 may perform inter-EPC node signaling for mobility between different RAT networks; PDN and S-GW selection as specified by MME 1406; MME selection for handovers; etc. The S3 reference point between the MME 1406 and the SGSN 1414 may enable user and bearer information exchange for inter-3GPP access network mobility in idle/active states.

The HSS 1416 may include a database for network users, including subscription-related information to support the network entities' handling of communication sessions. The HSS 1416 can provide support for routing/roaming, authentication, authorization, naming/addressing resolution, location dependencies, etc. An S6a reference point between the HSS 1416 and the MME 1406 may enable transfer of subscription and authentication data for authenticating/authorizing user access to the LTE CN 1418.

The PGW 1410 may terminate an SGi interface toward a data network (DN) 1422 that may include an application/content server 1420. The PGW 1410 may route data packets between the LTE CN 1424 and the data network 1422. The PGW 1410 may be coupled with the SGW 1408 by an S5 reference point to facilitate user plane tunneling and tunnel management. The PGW 1410 may further include a node for policy enforcement and charging data collection (for example, PCEF). Additionally, the SGi reference point between the PGW 1410 and the data network 1422 may be an operator external public, a private PDN, or an intra-operator packet data network, for example, for provision of IMS services. The PGW 1410 may be coupled with a PCRF 1412 via a Gx reference point.

The PCRF 1412 is the policy and charging control element of the LTE CN 1424. The PCRF 1412 may be communicatively coupled to the app/content server 1420 to determine appropriate QoS and charging parameters for service flows. The PCRF 1410 may provision associated rules into a PCEF (via Gx reference point) with appropriate TFT and QCI.

In some embodiments, the CN 1418 may be a 5GC 1452. The 5GC 1452 may include an AUSF 1432, AMF 1434, SMF 1436, UPF 1438, NSSF 1440, NEF 1442, NRF 1444, PCF 1446, UDM 1448, and AF 1450 coupled with one another over interfaces (or “reference points”) as shown. Functions of the elements of the 5GC 1452 may be briefly introduced as follows.

The AUSF 1432 may store data for authentication of UE 1402 and handle authentication-related functionality. The AUSF 1432 may facilitate a common authentication framework for various access types. In addition to communicating with other elements of the 5GC 1452 over reference points as shown, the AUSF 1432 may exhibit an Nausf service-based interface.

The AMF 1434 may allow other functions of the 5GC 1452 to communicate with the UE 1402 and the RAN 1430 and to subscribe to notifications about mobility events with respect to the UE 1402. The AMF 1434 may be responsible for registration management (for example, for registering UE 1402), connection management, reachability management, mobility management, lawful interception of AMF-related events, and access authentication and authorization. The AMF 1434 may provide transport for SM messages between the UE 1402 and the SMF 1436, and act as a transparent proxy for routing SM messages. AMF 1434 may also provide transport for SMS messages between UE 1402 and an SMSF. AMF 1434 may interact with the AUSF 1432 and the UE 1402 to perform various security anchor and context management functions. Furthermore, AMF 1434 may be a termination point of a RAN CP interface, which may include or be an N2 reference point between the RAN 1430 and the AMF 1434; and the AMF 1434 may be a termination point of NAS (N1) signaling, and perform NAS ciphering and integrity protection. AMF 1434 may also support NAS signaling with the UE 1402 over an N3 IWF interface.

The SMF 1436 may be responsible for SM (for example, session establishment, tunnel management between UPF 1438 and AN 1460); UE IP address allocation and management (including optional authorization); selection and control of UP function; configuring traffic steering at UPF 1438 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1434 over N2 to AN 1460; and determining SSC mode of a session. SM may refer to management of a PDU session, and a PDU session or “session” may refer to a PDU connectivity service that provides or enables the exchange of PDUs between the UE 1402 and the data network 1422.

The UPF 1438 may act as an anchor point for intra-RAT and inter-RAT mobility, an external PDU session point of interconnect to data network 1422, and a branching point to support multi-homed PDU session. The UPF 1438 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1438 may include an uplink classifier to support routing traffic flows to a data network.

The NSSF 1440 may select a set of network slice instances serving the UE 1402. The NSSF 1440 may also determine allowed NSSAI and the mapping to the subscribed S-NSSAIs, if needed. The NSSF 1440 may also determine the AMF set to be used to serve the UE 1402, or a list of candidate AMFs based on a suitable configuration and possibly by querying the NRF 1444. The selection of a set of network slice instances for the UE 1402 may be triggered by the AMF 1434 with which the UE 1402 is registered by interacting with the NSSF 1440, which may lead to a change of AMF. The NSSF 1440 may interact with the AMF 1434 via an N22 reference point; and may communicate with another NSSF in a visited network via an N31 reference point (not shown). Additionally, the NSSF 1440 may exhibit an Nnssf service-based interface.

The NEF 1442 may securely expose services and capabilities provided by 3GPP network functions for third party, internal exposure/re-exposure, AFs (e.g., AF 1450), edge computing or fog computing systems, etc. In such embodiments, the NEF 1442 may authenticate, authorize, or throttle the AFs. NEF 1442 may also translate information exchanged with the AF 1450 and information exchanged with internal network functions. For example, the NEF 1442 may translate between an AF-Service-Identifier and an internal 5GC information. NEF 1442 may also receive information from other NFs based on exposed capabilities of other NFs. This information may be stored at the NEF 1442 as structured data, or at a data storage NF using standardized interfaces. The stored information can then be re-exposed by the NEF 1442 to other NFs and AFs, or used for other purposes such as analytics. Additionally, the NEF 1442 may exhibit an Nnef service-based interface.

The NRF 1444 may support service discovery functions, receive NF discovery requests from NF instances, and provide the information of the discovered NF instances to the NF instances. NRF 1444 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1444 may exhibit the Nnrf service-based interface.

The PCF 1446 may provide policy rules to control plane functions to enforce them, and may also support unified policy framework to govern network behavior. The PCF 1446 may also implement a front end to access subscription information relevant for policy decisions in a UDR of the UDM 1448. In addition to communicating with functions over reference points as shown, the PCF 1446 exhibit an Npcf service-based interface.

The UDM 1448 may handle subscription-related information to support the network entities' handling of communication sessions, and may store subscription data of UE 1402. For example, subscription data may be communicated via an N8 reference point between the UDM 1448 and the AMF 1434. The UDM 1448 may include two parts, an application front end and a UDR. The UDR may store subscription data and policy data for the UDM 1448 and the PCF 1446, and/or structured data for exposure and application data (including PFDs for application detection, application request information for multiple UEs 1402) for the NEF 1442. The Nudr service-based interface may be exhibited by the UDR 221 to allow the UDM 1448, PCF 1446, and NEF 1442 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1448 may exhibit the Nudm service-based interface.

The AF 1450 may provide application influence on traffic routing, provide access to NEF, and interact with the policy framework for policy control.

In some embodiments, the 5GC 1452 may enable edge computing by selecting operator/3^{rd} party services to be geographically close to a point that the UE 1402 is attached to the network. This may reduce latency and load on the network. To provide edge-computing implementations, the 5GC 1452 may select a UPF 1438 close to the UE 1402 and execute traffic steering from the UPF 1438 to data network 1422 via the N6 interface. This may be based on the UE subscription data, UE location, and information provided by the AF 1450. In this way, the AF 1450 may influence UPF (re)selection and traffic routing. Based on operator deployment, when AF 1450 is considered to be a trusted entity, the network operator may permit AF 1450 to interact directly with relevant NFs. Additionally, the AF 1450 may exhibit an Naf service-based interface.

The data network 1422 may represent various network operator services, Internet access, or third party services that may be provided by one or more servers including, for example, application/content server 1420.

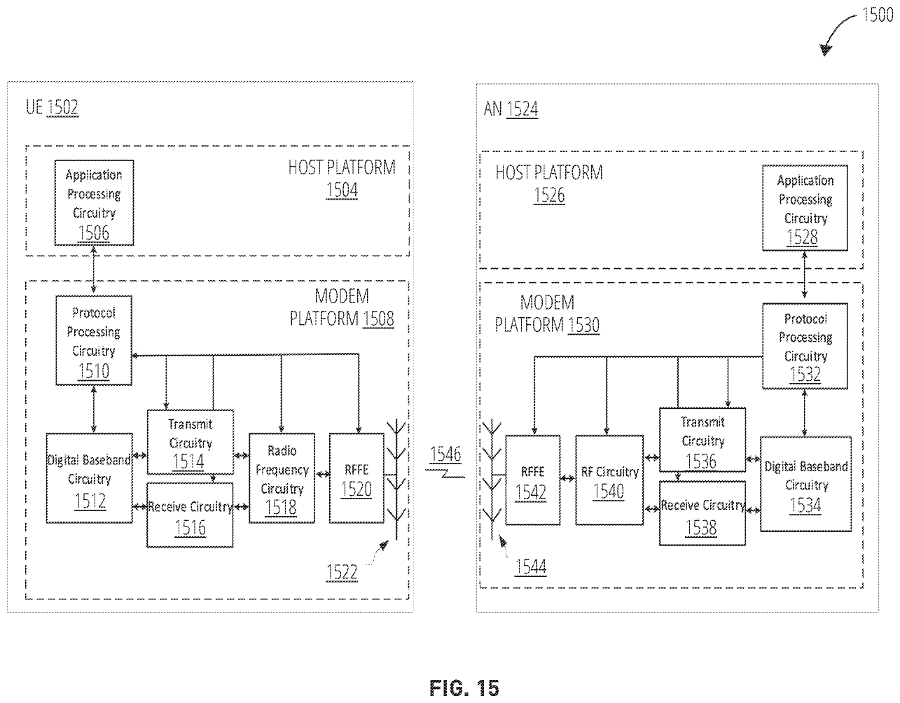

FIG. 15 schematically illustrates a wireless network 1500 in accordance with various embodiments. The wireless network 1500 may include a UE 1502 in wireless communication with an AN 1524. The UE 1502 and AN 1524 may be similar to, and substantially interchangeable with, like-named components described elsewhere herein.

The UE 1502 may be communicatively coupled with the AN 1524 via connection 1546. The connection 1546 is illustrated as an air interface to enable communicative coupling, and can be consistent with cellular communications protocols such as an LTE protocol or a 5G NR protocol operating at mmWave or sub-6 GHz frequencies.

The UE 1502 may include a host platform 1504 coupled with a modem platform 1508. The host platform 1504 may include application processing circuitry 1506, which may be coupled with protocol processing circuitry 1510 of the modem platform 1508. The application processing circuitry 1506 may run various applications for the UE 1502 that source/sink application data. The application processing circuitry 1506 may further implement one or more layer operations to transmit/receive application data to/from a data network. These layer operations may include transport (for example UDP) and Internet (for example, IP) operations

The protocol processing circuitry 1510 may implement one or more of layer operations to facilitate transmission or reception of data over the connection 1546. The layer operations implemented by the protocol processing circuitry 1510 may include, for example, MAC, RLC, PDCP, RRC and NAS operations.

The modem platform 1508 may further include digital baseband circuitry 1512 that may implement one or more layer operations that are “below” layer operations performed by the protocol processing circuitry 1510 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1508 may further include transmit circuitry 1514, receive circuitry 1516, RF circuitry 1518, and RF front end (RFFE) 1520, which may include or connect to one or more antenna panels 1522. Briefly, the transmit circuitry 1514 may include a digital-to-analog converter, mixer, intermediate frequency (IF) components, etc.; the receive circuitry 1516 may include an analog-to-digital converter, mixer, IF components, etc.; the RF circuitry 1518 may include a low-noise amplifier, a power amplifier, power tracking components, etc.; RFFE 1520 may include filters (for example, surface/bulk acoustic wave filters), switches, antenna tuners, beamforming components (for example, phase-array antenna components), etc. The selection and arrangement of the components of the transmit circuitry 1514, receive circuitry 1516, RF circuitry 1518, RFFE 1520, and antenna panels 1522 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1510 may include one or more instances of control circuitry (not shown) to provide control functions for the transmit/receive components.

A UE reception may be established by and via the antenna panels 1522, RFFE 1520, RF circuitry 1518, receive circuitry 1516, digital baseband circuitry 1512, and protocol processing circuitry 1510. In some embodiments, the antenna panels 1522 may receive a transmission from the AN 1524 by receive-beamforming signals received by a plurality of antennas/antenna elements of the one or more antenna panels 1522.

A UE transmission may be established by and via the protocol processing circuitry 1510, digital baseband circuitry 1512, transmit circuitry 1514, RF circuitry 1518, RFFE 1520, and antenna panels 1522. In some embodiments, the transmit components of the UE 1524 may apply a spatial filter to the data to be transmitted to form a transmit beam emitted by the antenna elements of the antenna panels 1522.

Similar to the UE 1502, the AN 1524 may include a host platform 1526 coupled with a modem platform 1530. The host platform 1526 may include application processing circuitry 1528 coupled with protocol processing circuitry 1532 of the modem platform 1530. The modem platform may further include digital baseband circuitry 1534, transmit circuitry 1536, receive circuitry 1538, RF circuitry 1540, RFFE circuitry 1542, and antenna panels 1544. The components of the AN 1524 may be similar to and substantially interchangeable with like-named components of the UE 1502. In addition to performing data transmission/reception as described above, the components of the A 1504 may perform various logical functions that include, for example, RNC functions such as radio bearer management, uplink and downlink dynamic radio resource management, and data packet scheduling.

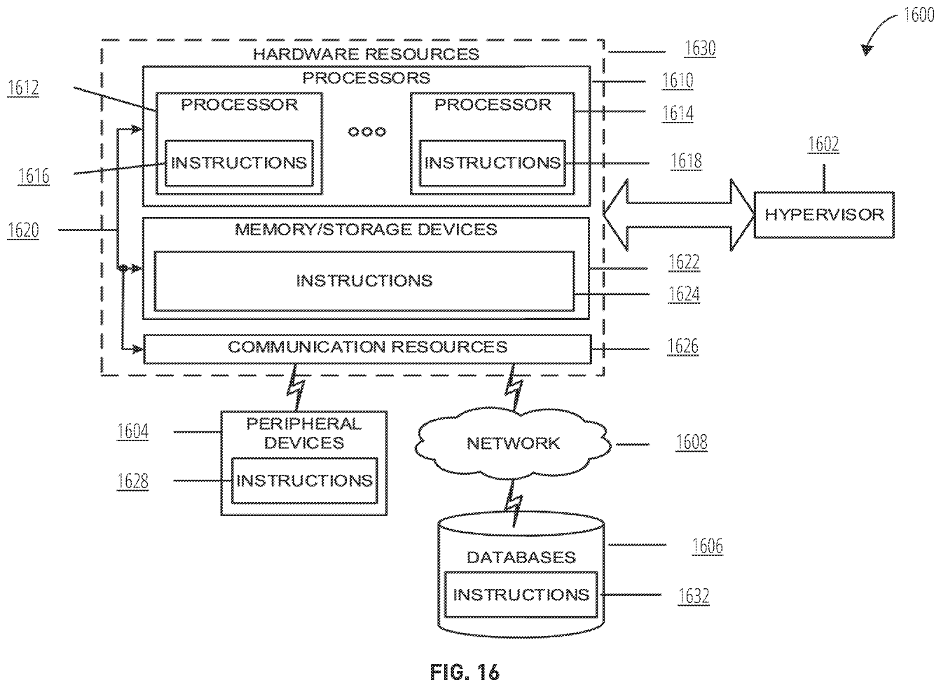

FIG. 16 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1630 including one or more processors (or processor cores) 1610, one or more memory/storage devices 1622, and one or more communication resources 1626, each of which may be communicatively coupled via a bus 1620 or other interface circuitry. For embodiments where node virtualization (e.g., NFV) is utilized, a hypervisor 1602 may be executed to provide an execution environment for one or more network slices/sub-slices to utilize the hardware resources 1630.

The processors 1610 may include, for example, a processor 1612 and a processor 1614. The processors 1610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1622 may include main memory, disk storage, or any suitable combination thereof. The memory/storage devices 1622 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1626 may include interconnection or network interface controllers, components, or other suitable devices to communicate with one or more peripheral devices 1604 or one or more databases 1606 or other network elements via a network 1608. For example, the communication resources 1626 may include wired communication components (e.g., for coupling via USB, Ethernet, etc.), cellular communication components, NFC components, Bluetooth® (or Bluetooth® Low Energy) components, Wi-Fi® components, and other communication components.

Instructions 106, 1618, 1624, 1628, 1632 may comprise software, a program, an application, an applet, an app, or other executable code for causing at least any of the processors 1610 to perform any one or more of the methodologies discussed herein. The instructions 106, 1618, 1624, 1628, 1632 may reside, completely or partially, within at least one of the processors 1610 (e.g., within the processor's cache memory), the memory/storage devices 1622, or any suitable combination thereof. Furthermore, any portion of the instructions 106, 1618, 1624, 1628, 1632 may be transferred to the hardware resources 1630 from any combination of the peripheral devices 1604 or the databases 1606. Accordingly, the memory of processors 1610, the memory/storage devices 1622, the peripheral devices 1604, and the databases 1606 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

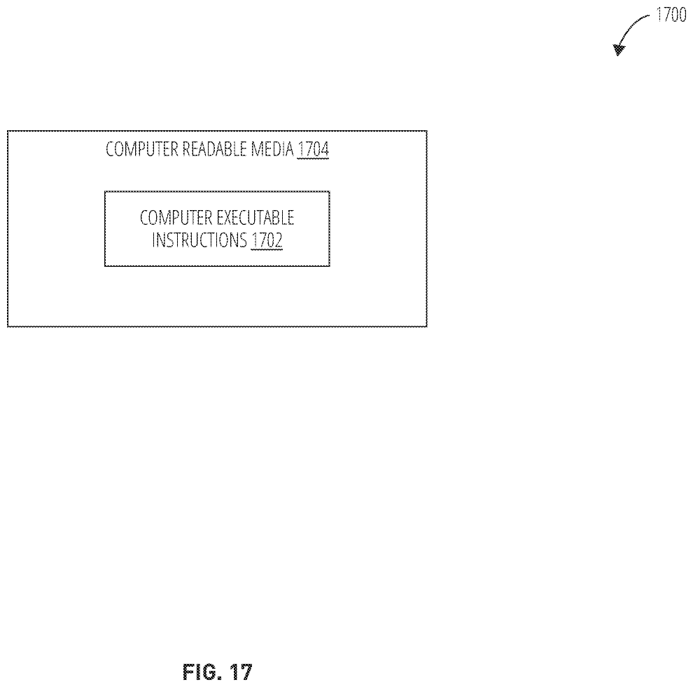

FIG. 17 illustrates computer readable storage medium 1700. Computer readable storage medium 1700 may comprise any non-transitory computer readable storage medium 1700 or machine-readable storage medium 1700, such as an optical, magnetic or semiconductor storage medium. In various embodiments, computer readable storage medium 1700 may comprise an article of manufacture. In some embodiments, computer readable storage medium 1700 may store computer executable instructions 1702 with which circuitry can execute. For example, computer executable instructions 1702 can include computer executable instructions 1702 to implement operations described with respect to logic flow 900, logic flow 1000, logic flow 1100, logic flow 1200, or message flow 1300. Examples of computer readable storage medium 1700 or machine-readable storage medium 1700 may include any tangible media capable of storing electronic data, including volatile memory or non-volatile memory, removable or non-removable memory, erasable or non-erasable memory, writeable or re-writeable memory, and so forth. Examples of computer executable instructions 1702 may include any suitable type of code, such as source code, compiled code, interpreted code, executable code, static code, dynamic code, object-oriented code, visual code, and the like.

### First Set of Examples

Example 1 may include a method of wireless communication for a fifth generation (5G) or new radio (NR) system: Configured, by a UE, a priority value for a sidelink positioning reference signal (SL PRS) transmission or reception; Determined, by a UE, whether SL PRS transmission or reception has higher priority than other transmission or reception in accordance with the configured priority value.

Example 2 may include the method of example 1 or some other example herein, wherein when one or more symbols for SL PRS transmission or reception overlaps with sidelink transmission or reception or uplink transmission with higher priority in time domain, and if UE is not capable of simultaneous transmission/reception of SL PRS and sidelink transmission/reception or uplink transmission in a carrier or two carriers, UE may cancel or drop the one or more symbols for SL PRS transmission or reception, respectively; wherein the UE may transmit or receive the SL PRS in the non-overlapping symbols.

Example 3 may include the method of example 1 or some other example herein, wherein when one or more symbols for SL PRS transmission or reception overlaps with sidelink transmission or reception or uplink transmission with higher priority in time domain, and if UE is not capable of simultaneous transmission/reception of SL PRS and sidelink transmission/reception or uplink transmission in a carrier or two carriers, UE may cancel or drop the whole SL PRS transmission or reception.

Example 4 may include the method of example 1 or some other example herein, wherein PRACH, Msg3 PUSCH initial transmission and retransmission, MsgA PUSCH, PUCCH carrying HARQ-ACK information of corresponding MsgB PDSCH transmission or Msg4 has higher priority than a SL PRS transmission or reception.

Example 5 may include the method of example 1 or some other example herein, wherein a measurement gap may be configured for SL PRS reception

Example 6 may include the method of example 1 or some other example herein, wherein the measurement gap may be configured in accordance with system frame duration, subframe duration, or physical slot.

Example 7 may include the method of example 1 or some other example herein, wherein a measurement gap may be configured in accordance with logical indexing of slots configured for a SL PRS resource pool.

Example 8 may include the method of example 1 or some other example herein, wherein a measurement gap may be activated or deactivated via Medium Access Control-Control Element (MAC-CE) or sidelink control information (SCI) format.

Example 9 may include the method of example 1 or some other example herein, wherein SL PRS processing window may be provided to a UE for SL PRS reception via higher layer (pre-) configuration and/or dynamic indication

Example 10 may include the method of example 1 or some other example herein, wherein SL PRS processing window may be configured in accordance with the subframe index or physical slot index

Example 11 may include the method of example 1 or some other example herein, wherein the SL PRS processing window may be configured in accordance with the logical indexing of slots configured for the SL PRS resource pool when dedicated SL PRS resource pool is configured for SL PRS transmission and measurement

Example 12 may include the method of example 1 or some other example herein, wherein SL PRS processing window may be activated or deactivated via Medium Access Control-Control Element (MAC-CE) or sidelink control information (SCI) format.

Example 13 may include the method of example 1 or some other example herein, wherein when a UE receives SL PRS within a SL PRS processing window, and when the UE determines that SL PRS has higher priority than sidelink physical channels/signals or uplink physical channels/signals, the UE is expected to measure the SL PRS and not expected to transmit or receive other sidelink physical channels/signals and/or transmit uplink physical channels/signals.

Example 14 may include the method of example 1 or some other example herein, wherein no priority level is defined for a SL PRS transmission or reception.

Example 15 may include the method of example 1 or some other example herein, wherein for prioritization between a SL PRS transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 1, the UL transmission has higher priority than the SL PRS transmission or reception.

Example 16 may include the method of example 1 or some other example herein, wherein no priority level is defined for a SL PRS transmission or reception; wherein for prioritization between a SL PRS transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 0, the UL transmission has higher priority than the SL PRS transmission or reception

Example 17 may include the method of example 1 or some other example herein, wherein no priority level is defined for a SL PRS transmission or reception; wherein for prioritization between a SL PRS transmission/reception and a PUCCH or PUSCH transmission with a sidelink HARQ-ACK information report, the PUCCH transmission has higher priority than the SL PRS transmission or reception if the priority value of the PUCCH transmission is smaller than a threshold, which can be configured or pre-configured by higher layers

Example 18 may include the method of example 1 or some other example herein, wherein the PUCCH or PUSCH transmission with a sidelink HARQ-ACK information report always has higher priority than the SL PRS transmission or reception

Example 19 may include the method of example 1 or some other example herein, wherein for prioritization between a SL PRS transmission/reception and a SL transmission for SL communication including PSSCH/PSCCH, S-SS/PSBCH block and PSFCH, or a SL reception including S-SS/PSBCH block and PSFCH, the SL transmission or reception for SL communication has higher priority than the SL PRS transmission or reception if a priority value of the SL transmission or reception for SL communication is smaller than a threshold, which can be configured or pre-configured by higher layers

Example 20 may include the method of example 1 or some other example herein, wherein one or more than one priority may be defined for the transmission/reception of SL PRS for sidelink positioning; wherein one field may be included in the 1st stage or 2nd stage SCI format to indicate the priority value for SL PRS transmission.

Example 21 may include the method of example 1 or some other example herein, wherein when one or more than one priority value is defined for SL PRS transmission and/or reception, for prioritization between a SL PRS transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 1, when the priority value of the SL PRS transmission or reception is smaller than a priority threshold, which can be configured or pre-configured by higher layers, the SL PRS transmission or reception has higher priority than the UL transmission

Example 22 may include the method of example 1 or some other example herein, wherein when one or more than one priority value is defined for SL PRS transmission and/or reception, for prioritization between a SL PRS transmission/reception and UL transmissions other than a PRACH, or a PUSCH scheduled by an UL grant in a RAR and its retransmission, or a PUSCH corresponding to Type-2 random access procedure and its retransmission, or a PUCCH with sidelink HARQ-ACK information report, if the UL transmission is for a PUSCH or for a PUCCH with priority index 0, when the priority value of the SL PRS transmission or reception is smaller than a priority threshold, which can be configured or pre-configured by higher layers, the SL PRS transmission or reception has higher priority than the UL transmission

Example 23 may include the method of example 1 or some other example herein, wherein when one or more than one priority value is defined for SL PRS transmission and/or reception, for prioritization between a SL PRS transmission/reception and a PUCCH or PUSCH transmission with a sidelink HARQ-ACK information report, the PUCCH or PUSCH transmission has higher priority than the SL PRS transmission or reception if a priority value of the PUCCH or PUSCH transmission is smaller than a priority value of the SL PRS transmission or reception

Example 24 may include the method of example 1 or some other example herein, wherein when one or more than one priority value is defined for SL PRS transmission and/or reception, for prioritization between a SL PRS transmission/reception and a SL transmission for SL communication including PSSCH/PSCCH, S-SS/PSBCH block and PSFCH, or a SL reception including S-SS/PSBCH block and PSFCH, the SL transmission or reception for SL communication has higher priority than the SL PRS transmission or reception if a priority value of the SL transmission or reception for SL communication is smaller than a priority value of the SL PRS transmission or reception.

Example 25 may include the method of example 1 or some other example herein, wherein in case of a shared resource pool for SL communication and SL positioning, the value of priority field that is indicated in the 1st stage SCI may be determined in accordance with a function of priority value for SL communication and priority value for SL PRS.

Example 26 may include the method of example 1 or some other example herein, wherein the value of priority field that is indicated in the 1st stage SCI may correspond to the higher of the priority value for SL communication and the priority value for SL PRS.

Example 27 may include the method of example 1 or some other example herein, wherein when SL PRS is not scheduled in the shared resource pool and the 1st stage SCI indicates a new 2nd stage SCI format associated with SL PRS scheduling, the value of priority field that is indicated in the 1st stage SCI may correspond to the priority value for SL communication.

Example 28 may include the method of example 1 or some other example herein, wherein when SL PRS is scheduled but PSSCH carrying SL-SCH is not scheduled in the shared resource pool, the value of priority field that is indicated in the 1st stage SCI may correspond to the priority value for SL PRS.

Example 29 may include the method of example 1 or some other example herein, wherein when SL PRS is not scheduled in the shared resource pool, priority field may still be present in the 2nd stage SCI.

Example 30 may include the method of example 1 or some other example herein, wherein for a dedicated resource pool, when only PSCCH and SL PRS are included, priority field may be included in a single SCI format, where the value of priority field may correspond to the priority value for SL PRS.

Example 31 may include a method of wireless communication that includes: determining that one or more symbols for sidelink positioning reference signal (SL PRS) transmission or reception overlaps with a sidelink transmission or reception or uplink transmission of a user equipment (UE); determining that either the one or more symbols for SL PRS transmission or reception, the sidelink transmission or reception, or the uplink transmission is a prioritized communication in accordance with a prioritization rule; communicating the prioritized communication with the UE; dropping at least one of the one or more symbols for SL PRS transmission or reception, the sidelink transmission or reception, or the uplink transmission that is not the prioritized communication.

Example 32 may include the method of example 31 or some other example herein, wherein: the SL PRS transmission partially overlaps with an uplink transmission; dropping the at least one of the one or more symbols for SL PRS transmission or reception, the sidelink transmission or reception, or the uplink transmission that is not the prioritized communication comprises dropping only a portion of the SL PRS transmission that overlaps with the uplink transmission.

Example 33 may include the method of example 31 or some other example herein, wherein: the SL PRS transmission partially overlaps with an uplink transmission; dropping the at least one of the one or more symbols for SL PRS transmission or reception, the sidelink transmission or reception, or the uplink transmission that is not the prioritized communication comprises dropping all of the SL PRS transmission.

Example 34 may include the method of example 32 or example 33, wherein the uplink transmission is at least one of a Physical Uplink Shared Channel (PUSCH) transmission or a Physical Uplink Control Channel (PUCCH) transmission.

Example 35 may include the method of example 31 or some other example herein, wherein the prioritized communication is the SL PRS transmission and the least one of the one or more symbols for SL PRS transmission or reception, the sidelink transmission or reception, or the uplink transmission that is not the prioritized communication is the uplink transmission, wherein the method further comprises: measuring the SL PRS transmission.

Example 36 may include the method of example 31 or some other example herein, wherein for a shared resource pool for SL communication and SL positioning, a value of a priority field in a 1st stage SCI is determined in accordance with a function of a first priority value for SL communication and a second priority value for SL PRS.

Example 37 may include the method of example 36 or some other example herein, wherein the value of the priority field corresponds to the higher of the first priority value and the second priority value.

### Second Set of Examples

In one example, a method to manage communications for a user equipment (UE), includes detecting a set of overlapping symbols between a sidelink (SL) positioning reference signal (PRS) (SL PRS) and a message in a slot for a frame in a time domain of a new radio (NR) system, retrieving priority information for the SL PRS from a data storage device, and determining a schedule for transmission or reception of the SL PRS and the message based on the priority information.

The method may also include where the message includes data for a SL transmission or an uplink (UL) transmission.

The method may also include determining the SL PRS has a lower priority and the message has a higher priority, scheduling the message with the higher priority for transmission or reception, dropping the set of overlapping symbols for the SL PRS with a lower priority, and scheduling a set of non-overlapping symbols for the SL PRS for transmission or reception.

The method may also include determining the SL PRS has a lower priority and the message has a higher priority, scheduling the message with the higher priority for transmission or reception, and dropping all the symbols for the SL PRS with a lower priority.

The method may also include determining the SL PRS has a higher priority and the message has a lower priority, scheduling the SL PRS with the higher priority for transmission or reception, and dropping all the symbols for the message with a lower priority.

The method may also include determining the SL PRS does not have a priority level, and scheduling the message for transmission or reception as a default.

The method may also include decoding sidelink scheduling information for the SL PRS from sidelink control information (SCI) in a first stage (1st-stage) SCI format carried on a physical sidelink control channel (PSCCH) or a second stage (2nd-stage) SCI format carried on a physical sidelink shared channel (PSSCH), where one information field for the 1st-stage SCI format or the 2nd-stage SCI format indicates the priority information for the SL PRS, retrieving the priority information from the information field, and storing the priority information in the data storage device.

The method may also include decoding sidelink scheduling information for the SL PRS from sidelink control information (SCI) in a first stage (1st-stage) SCI format 1-B carried on a physical sidelink control channel (PSCCH), the SCI format 1-B includes information fields for a priority, a source identifier (ID), a destination ID, a cast type indicator, or a resource reservation period, where the Nrsv-period is a number of entries in a higher layer parameter sl-PRSResourceReservePeriodList, if a higher layer parameter sl-PRSResourceReservePeriodList is configured; and a 0 bit otherwise.

The method may also include decoding sidelink scheduling information for the SL PRS from sidelink control information (SCI) in a second stage (2nd-stage) SCI format 2-D carried on a physical sidelink shared channel (PSSCH), the SCI format 2-D includes information fields for a hybrid automatic repeat request (HARQ) process number includes 4 bits, a new data indicator includes 1 bit, a redundancy version includes 2 bits, a source identifier (ID) comprise 8 bits, a destination ID includes 16 bits, or a HARQ feedback enabled/disabled indicator includes 1 bit. Other technical features may be readily apparent to one skilled in the art from the following figures, descriptions, and claims.

In one aspect, an apparatus for a user equipment (UE), includes a memory interface to send or receive, to or from a data storage device, priority information for transmission or reception of a sidelink positioning reference signal (SL PRS) in a new radio (NR) system. The apparatus also includes processor circuitry communicatively coupled to the memory interface, the processor circuitry to detect a set of overlapping symbols between SL PRS and a message in a slot for a frame in a time domain of the NR system, retrieve the priority information for the SL PRS from a data storage device, and determine a schedule for transmission or reception of the SL PRS and the message based on the priority information for the SL PRS.

The apparatus may also include the processor circuitry to determine the SL PRS has a lower priority and the message has a higher priority, schedule the message with the higher priority for transmission or reception, drop the set of overlapping symbols for the SL PRS with a lower priority, and schedule a set of non-overlapping symbols for the SL PRS for transmission or reception.

The apparatus may also include the processor circuitry to determine the SL PRS has a lower priority and the message has a higher priority, schedule the message with the higher priority for transmission or reception, and drop all the symbols for the SL PRS with a lower priority.

The apparatus may also include the processor circuitry to determine the SL PRS has a higher priority and the message has a lower priority, schedule the SL PRS with the higher priority for transmission or reception, and drop all the symbols for the message with a lower priority.

The apparatus may also include the processor circuitry to determine the SL PRS does not have a priority level, and schedule the message for transmission or reception as a default.

The apparatus may also include the processor circuitry to decode sidelink scheduling information for the SL PRS from sidelink control information (SCI) in a first stage (1st-stage) SCI format 1-B carried on a physical sidelink control channel (PSCCH), the SCI format 1-B includes information fields for a priority, a source identifier (ID), a destination ID, a cast type indicator, or a resource reservation period, where the Nrsv-period is a number of entries in a higher layer parameter sl-PRSResourceReservePeriodList, if a higher layer parameter sl-PRSResourceReservePeriodList is configured; and a 0 bit otherwise.

The apparatus may also include the processor circuitry to decode sidelink scheduling information for the SL PRS from sidelink control information (SCI) in a second stage (2nd-stage) SCI format 2-D carried on a physical sidelink shared channel (PSSCH), the SCI format 2-D includes information fields for a hybrid automatic repeat request (HARQ) process number includes 4 bits, a new data indicator includes 1 bit, a redundancy version includes 2 bits, a source identifier (ID) comprise 8 bits, a destination ID includes 16 bits, or a HARQ feedback enabled/disabled indicator includes 1 bit. Other technical features may be readily apparent to one skilled in the art from the following figures, descriptions, and claims.

In one aspect, a non-transitory computer-readable storage medium, the computer-readable storage medium including instructions that when executed by a computer, cause the computer to detect a set of overlapping symbols between a sidelink (SL) positioning reference signal (PRS) (SL PRS) and a message in a slot for a frame in a time domain of a new radio (NR) system, retrieve priority information for the SL PRS from a data storage device, and determine a schedule for transmission or reception of the SL PRS and the message based on the priority information.

The computer-readable storage medium may also include instructions to determine the SL PRS has a lower priority and the message has a higher priority, schedule the message with the higher priority for transmission or reception, drop the set of overlapping symbols for the SL PRS with a lower priority, and schedule a set of non-overlapping symbols for the SL PRS for transmission or reception.

The computer-readable storage medium may also include instructions to determine the SL PRS has a lower priority and the message has a higher priority, schedule the message with the higher priority for transmission or reception, and drop all the symbols for the SL PRS with a lower priority.

The computer-readable storage medium may also include instructions to determine the SL PRS has a higher priority and the message has a lower priority, schedule the SL PRS with the higher priority for transmission or reception, and drop all the symbols for the message with a lower priority.

The computer-readable storage medium may also include instructions to decode sidelink scheduling information for the SL PRS from sidelink control information (SCI) in a first stage (1st-stage) SCI format 1-B carried on a physical sidelink control channel (PSCCH), the SCI format 1-B includes information fields for a priority, a source identifier (ID), a destination ID, a cast type indicator, or a resource reservation period, where the Nrsv-period is a number of entries in a higher layer parameter SL PRSResourceReservePeriodList, if a higher layer parameter SL PRSResourceReservePeriodList is configured; and a 0 bit otherwise.

The computer-readable storage medium may also include instructions to decode sidelink scheduling information for the SL PRS from sidelink control information (SCI) in a second stage (2nd-stage) SCI format 2-D carried on a physical sidelink shared channel (PSSCH), the SCI format 2-D includes information fields for a hybrid automatic repeat request (HARQ) process number includes 4 bits, a new data indicator includes 1 bit, a redundancy version includes 2 bits, a source identifier (ID) comprise 8 bits, a destination ID includes 16 bits, or a HARQ feedback enabled/disabled indicator includes 1 bit. Other technical features may be readily apparent to one skilled in the art from the following figures, descriptions, and claims.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to providing a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1-40. (canceled)

41. An apparatus for a user equipment (UE), comprising:
an interface for communication; and
processor circuitry communicatively coupled to the interface, the processor circuitry to:
decode sidelink scheduling information from information fields of a sidelink control information (SCI) format 1-B from a physical sidelink control channel (PSCCH) of a wireless system;
determine a schedule for transmission or reception of a sidelink positioning reference signal (SL PRS) based on the sidelink scheduling information; and
cause the transmission or the reception of the SL PRS based on the schedule via the interface.

42. The apparatus of claim 41, wherein the SCI format 1-B is used for scheduling the SL PRS for a dedicated resource pool.

43. The apparatus of claim 41, wherein the SCI format 1-B comprises information fields for a priority, a source identifier (ID), a destination ID, a cast type indicator, or a resource reservation period.

44. The apparatus of claim 41, wherein the SCI format 1-B comprises information fields for a priority value of 3 bits, a source identifier (ID) value of 12 or 24 bits, a destination ID value of 24 bits, a cast type indicator of 2 bits, or a resource reservation period of [log2Nrsv_period] bits, where the Nrsv_period is a number of entries in a higher layer parameter, if the higher layer parameter is configured; and a 0 bit otherwise.

45. The apparatus of claim 43, the processor circuitry to:
determine a priority value for the SL PRS from an information field for the priority; and
determine the schedule for transmission or reception of the SL PRS based on the priority value.

46. The apparatus of claim 41, comprising radio frequency circuitry coupled to the processing circuitry via the interface, and one or more antennas coupled with the radio frequency circuitry.

47. An apparatus for a user equipment (UE), comprising:
an interface for communication; and
processor circuitry communicatively coupled to the interface, the processor circuitry to:
decode priority information for a sidelink (SL) channel of a wireless system;
determine a schedule for transmission or reception of SL information over the SL channel based on the priority information; and
cause the transmission or the reception of the SL information based on the schedule via the interface.

48. The apparatus of claim 47, wherein the priority information comprises a threshold value used to determine whether transmission of a sidelink positioning reference signal (SL PRS) is prioritized over an uplink transmission of priority index 0.

49. The apparatus of claim 47, wherein the priority information comprises a threshold value used to determine whether transmission of a sidelink positioning reference signal (SL PRS) is prioritized over an uplink transmission of priority index 1.

50. The apparatus of claim 47, wherein the priority information comprises a threshold value used to determine whether a physical uplink control channel (PUCCH) transmission carrying a sidelink hybrid automatic repeat request (SL HARQ) is prioritized over a PUCCH transmission carrying uplink control information (UCI) of priority index 0 if they overlap in time.

51. The apparatus of claim 47, wherein the priority information comprises a threshold value used to determine whether a physical uplink control channel (PUCCH) transmission carrying a sidelink hybrid automatic repeat request (SL HARQ) is prioritized over a PUCCH transmission carrying uplink control information (UCI) of priority index 1 if they overlap in time.

52. An apparatus for a user equipment (UE), comprising:
an interface for communication; and
processor circuitry communicatively coupled to the interface, the processor circuitry to:
decode priority information for a sidelink (SL) channel of a wireless system;
determine a schedule for a transmission or reception on the SL or an uplink (UL) based on the priority information; and
cause the transmission or reception on the UL or the SL based on the schedule.

53. The apparatus of claim 52, the processor circuitry to:
determine the UE would simultaneously transmit on the UL and on the SL in a carrier or in two respective carriers;
determine the UE is not capable of simultaneous transmissions on the UL and on the SL in the carrier or in the two respective carriers; and
cause the transmission on the UL or SL with a higher priority based on the priority information.

54. The apparatus of claim 52, the processor circuitry to:
determine the UE would simultaneously transmit on the UL and on the SL in a carrier; or
determine the UE would simultaneously transmit on the UL and receive on the SL in two respective carriers and is not capable of simultaneous transmissions on the UL and reception on the SL in the two respective carriers; and
cause the transmission on the UL or reception on the SL with a higher priority based on the priority information.

55. The apparatus of claim 52, the processor circuitry to determine if the transmission on the UL is for a PUSCH or for a PUCCH with priority index 1.

56. The apparatus of claim 55, the processor circuitry to determine the transmission or the reception on the SL has a higher priority than the transmission on the UL if a priority value of the transmission or the reception on the SL is smaller than a priority threshold.

57. The apparatus of claim 56, the processor circuitry to otherwise determine the transmission or the reception on the UL has a higher priority than the transmission or reception on the SL.

58. The apparatus of claim 57, the processor circuitry to else determine the transmission on the UL has a higher priority than the transmission or reception on the SL.

59. The apparatus of claim 52, the processor circuitry to else determine the transmission or the reception on the SL has a higher priority than the transmission on the UL if a priority value of the transmission or the reception on the SL is smaller than a priority threshold.

60. The apparatus of claim 59, the processor circuitry to otherwise determine the transmission on the UL has a higher priority than the transmission or reception on the SL.
